(19) United States
(12) Patent Application Publication
(10) Pub. No.: US 2025/0230690 A1
(43) Pub. Date: Jul. 17, 2025

(54) CLOSURE LATCH ASSEMBLY EQUIPPED WITH CHILD LOCK MECHANISM AND POWER RELEASE MECHANISM HAVING DIRECTIONAL CONTROLLING ACTUATION OF THE CHILD LOCK MECHANISM

(71) Applicant: MAGNA CLOSURES INC., Newmarket (CA)

(72) Inventors: Marco TAURASI, Newmarket (CA); Francesco CUMBO, Newmarket (CA)

(21) Appl. No.: 19/171,320

(22) Filed: Apr. 6, 2025

Related U.S. Application Data
(63) Continuation of application No. 17/678,201, filed on Feb. 23, 2022.
(60) Provisional application No. 63/253,351, filed on Oct. 7, 2021.
(60) Provisional application No. 63/214,267, filed on Jun. 24, 2021.
(60) Provisional application No. 63/174,292, filed on Apr. 13, 2021.
(60) Provisional application No. 63/162,881, filed on Mar. 18, 2021.

(51) Int. Cl. E05B 81/16; E05B 77/30; E05B 81/06; E05B 81/24

(52) U.S. Cl. CPC E05B 81/16; E05B 81/24; E05B 77/30; E05B 81/06

(57) ABSTRACT

A closure latch assembly and system for a vehicle closure panel equipped with a latch mechanism having a latched position and an unlatched position and a power release mechanism moveable between home position, a release position and a double pull position and/or a child lock position, wherein a single motor is operable to move the power release mechanism between from the home position to the release position and from the home position to the double pull position and/or the child lock position.

### CROSS-REFERENCE TO RELATED APPLICATIONS

This continuation application claims the benefit of U.S. application Ser. No. 17/678,201, filed Feb. 23, 2022, of U.S. Provisional Application Ser. No. 63/253,351, filed Oct. 7, 2021, of U.S. Provisional Application Ser. No. 63/214,267, filed Jun. 24, 2021, of U.S. Provisional Application Ser. No. 63/174,292, filed Apr. 13, 2021, and of U.S. Provisional Application Ser. No. 63/162,881, filed Mar. 18, 2021, which are each incorporated herein by reference in their entirety.

### FIELD

The present disclosure relates generally to closure latches for a vehicle passenger door. More particularly, the present disclosure is directed to a closure latch equipped with a power release actuator and a child lock mechanism.

### BACKGROUND

This section provides background information related to closure latches and is not necessarily prior art to the closure latch of the present disclosure.

Passive entry systems for vehicles are provided on some vehicles to permit a vehicle user who is in possession of the key fob to simply pull the door handle and open the door without the need to introduce a key into a keyhole in the door. The key fob is typically equipped with an electronic device that communicates with the vehicle's on-board control system to authenticate the user. When the user pulls the outside door handle to indicate that he/she wishes entry into the vehicle, an electric actuator associated with a door-mounted closure latch is actuated to release a latch mechanism so as to unlatch the door and permit subsequent movement of the door to its open position. The outside door handle may also be equipped with a switch that triggers the electric actuator. The latch mechanism may also be mechanically released from inside the vehicle since the inside door handle is connected to an inside release mechanism associated with the closure latch. In some jurisdictions, however, there are regulations that govern the degree of connection provided by the inside release mechanism between the inside door handle and the latch mechanism (particularly for a rear door, where children may be the occupants).

Many modern closure latches provide various power-operated features including power release, power lock and power child lock in addition to a double pull inside release function. However, integration of such a double pull inside release function and power child lock into most closure latches requires the addition of a supplemental power-operated actuator or requires complex arrangements using the power release actuator. While commercially-available closure latches are satisfactory to meet operational and regulatory requirements, a need still exists to advance the technology to provide closure latches having reduced complexity and packaging while providing the desired power-operated features, double pull inside release and child lock function. One specific need relates to utilizing an existing power-operated actuator, such as a power release actuator, to manage power release, the double pull activation and double pull release function, as well as child lock activation and deactivation. A further need relates to providing an ability open a rear door in the event power is interrupted to the power-operated actuator. Accordingly, advances are continually being sought to address at least those issues discussed above.

### SUMMARY

This section provides a general summary of the disclosure and is not intended to be considered as a comprehensive and exhaustive listing of its full scope or all of its aspects, features and objectives.

It is an aspect of the present disclosure to provide a closure latch assembly for a vehicle closure panel, such as passenger door, having a power release actuator movable between a home position, whereat a latch mechanism is in a latched position, a release position, whereat the latch mechanism is in an unlatched position, and a double pull lock position, whereat the latch mechanism is prevented from moving to the unlatched position during a single pull of an inside door handle or upon performing a single actuation of the power release actuator.

It is another aspect of the present disclosure to provide the closure latch assembly with a power release actuator having a single motor, wherein the single motor is operable to move the power release actuator between the home position, the release position, and the double pull lock position.

It is another aspect of the present disclosure to configure the power release actuator having a single motor so that the power release actuator can move from the double pull lock position to the release position upon performing a double actuation of the power release actuator.

In accordance with these and other aspects, a closure latch assembly for a vehicle door includes a latch mechanism including a ratchet and a pawl, the ratchet being moveable between a striker capture position and a striker release position, the pawl being moveable between a ratchet holding position, whereat the pawl holds the ratchet in its striker capture position, and a ratchet releasing position, whereat the pawl permits the ratchet to move to its striker release position. The closure latch assembly has a power release mechanism that is moveable by a single actuator between a home position, whereat the pawl can be moved from the ratchet holding position to the ratchet releasing position upon a single actuation of the power release mechanism and/or upon a single actuation of an inside handle of the vehicle door, and at least one of a double pull lock position and/or a child lock position, whereat the pawl cannot be moved from the ratchet holding position to the ratchet releasing position upon a single actuation of the power release mechanism and/or upon a single actuation of an inside handle.

In accordance with another aspect, the pawl, while the power release mechanism is in the double pull lock position, can be moved from the ratchet holding position to the ratchet releasing position upon performing a double actuation of the power release mechanism or upon performing a double actuation of the inside handle.

In accordance with another aspect, the power release mechanism can be configured to move from the home position to the release position upon actuation of the single actuator to move the pawl from the ratchet holding position to the ratchet releasing position.

In accordance with another aspect, the power release mechanism can be configured to move directly from the double pull lock position to the release position upon performing the double actuation of the power release mechanism.

In accordance with another aspect, a closure latch assembly for a vehicle door is provided, including a single motor; a release chain; and a double lock mechanism having a single pull state and a double pull state, where the activation of the single motor operates to perform a select one of: power release of the closure latch assembly, put the double lock mechanism in the single pull state, whereat a single actuation of the release chain functions to release the closure latch assembly, and put the double lock mechanism in the double pull state, whereat a double actuation of the release chain functions to release the closure latch assembly.

In accordance with another aspect, the single motor is operable to perform each of: power release the latch mechanism to the unlatched position, put the double lock mechanism in the single pull state, and put the double lock mechanism in the double pull state at separate times depending on a command provided and an operation desired.

In accordance with another aspect, a closure latch assembly for a vehicle door is provided having a latched state, an unlatched state, and a double pull state, wherein a single motor is operable to move a latch mechanism of the closure latch assembly from a latched position, whereat the closure latch assembly is in the latched state, to an unlatched position, whereat the closure latch assembly is in the unlatched state, from the latched position to a double pull position, whereat the closure latch assembly is in the double pull state, and from the double pull position to the unlatched position.

It is a further aspect of the present disclosure to provide a closure latch assembly for a vehicle closure panel, such as a rear passenger door, having a power release actuator movable between a home position, whereat a latch mechanism is in a latched position, a release position, whereat the latch mechanism is in an unlatched position, and a child lock position, whereat the latch mechanism is prevented from moving from the latched position to the unlatched position during an actuation of an inside rear door handle.

It is another aspect of the present disclosure to provide the closure latch assembly with the power release actuator being a single motor, wherein the single motor is operable to move the power release actuator between the home position, the release position, and the child lock position.

It is another aspect of the present disclosure to configure the single motor so that it can move the power release mechanism from the release position to the child lock position upon actuating a child lock switch, thereby disabling an inside door handle from being actuatable to open an associated rear door.

In accordance with another aspect of the present disclosure, the power release mechanism can be configured so that it is not moveable to the child lock position via a manually moveable externally accessible child lock lever, but only by the single motor.

In accordance with another aspect of the present disclosure, an emergency mechanical release member can be configured for manual actuation to move a latch mechanism of the closure latch assembly from a latched position to an unlatched position while the power release mechanism is in the child lock position to allow the rear door to be opened in the event power is interrupted to the power-operated actuator, wherein the emergency mechanical release member is concealed behind an emergency access lid.

In accordance with these and other aspects, a closure latch assembly for a rear vehicle door includes a latch mechanism including a ratchet and a pawl, the ratchet being moveable between a striker capture position and a striker release position, the pawl being moveable between a ratchet holding position, whereat the pawl holds the ratchet in its striker capture position, and a ratchet releasing position, whereat the pawl permits the ratchet to move to its striker release position. The closure latch assembly has a power release mechanism that is moveable by a single actuator between a home position, whereat the pawl can be moved from the ratchet holding position to the ratchet releasing position upon actuation of a rear door actuator, and a child lock position, whereat the pawl cannot be moved from the ratchet holding position to the ratchet releasing position upon actuation of the rear door actuator.

In accordance with another aspect of the present disclosure, the rear door actuator can be provided as a rear door handle configured in electrical communication with the closure latch assembly.

In accordance with another aspect of the present disclosure, the rear door actuator can be configured such that it is not in mechanical communication with the closure latch assembly.

In accordance with another aspect of the present disclosure, an emergency backup mechanism can configured in mechanically coupled communication with the latch mechanism to provide an override of the power release mechanism while in the child lock position, thereby allowing the pawl to be moved to the ratchet releasing position.

In accordance with another aspect of the present disclosure, the emergency backup mechanism can be made accessible via an access opening in an inner door panel of the vehicle door.

In accordance with another aspect of the present disclosure, a child lock button accessible inside the motor vehicle can be configured in electrical communication with the single actuator to move the power release mechanism between the home position and the child lock position.

In accordance with another aspect of the present disclosure, a closure latch system for a vehicle door having a power release mechanism moveable by a single motor from a home position to a release position via actuation of an inside door handle of the vehicle door is provided, whereupon a latch mechanism is moved from a latched position to an unlatched position, wherein the single motor is configured to selectively move the power release mechanism to a child lock position, whereat the latch mechanism cannot be moved from the latched position to the unlatched position via actuation of the inside door handle.

In accordance with another aspect of the present disclosure, a child lock switch can be configured in electrical communication with a controller, wherein the controller is configured to signal the single actuator to move the power release mechanism between the home position and the child lock position in response to selective actuation of the child lock switch between a child lock ON position, whereat the single actuator moves the power release mechanism from the home position to the child lock position, and a child lock OFF position, whereat the single actuator moves the power release mechanism from the child lock position to the home position.

In accordance with another aspect of the present disclosure, a closure latch system for a vehicle door has a latch mechanism including a ratchet and a pawl, with the ratchet being moveable between a striker capture position and a striker release position, and with the pawl being moveable between a ratchet holding position, whereat the pawl holds the ratchet in its striker capture position, and a ratchet releasing position, whereat the pawl permits the ratchet to move to its striker release position. A power release mechanism is provided that is moveable by a single actuator between a home position, whereat the pawl can be moved from the ratchet holding position to the ratchet releasing position by the power release mechanism by performing a single actuation of an inside door handle by moving the inside door handle from a rest position to a first deployed position, a lock position, whereat the pawl cannot be moved from the ratchet holding position to the ratchet releasing position by the power release mechanism by performing a single actuation of the inside door handle by moving the inside door handle from the rest position to the first deployed position, and a child lock position, whereat the pawl cannot be moved from the ratchet holding position to the ratchet releasing position upon actuation of the inside door handle.

In accordance with another aspect of the present disclosure, the closure latch system, wherein while in the lock position, the pawl can be moved from the ratchet holding position to the ratchet releasing position by the power release mechanism by performing a double actuation of the inside door handle by moving the inside door handle from the rest position to the first deployed position, twice.

In accordance with another aspect of the present disclosure, the inside door handle can be configured in electrical communication with the power release mechanism.

In accordance with another aspect of the present disclosure, an emergency backup mechanism is configured in mechanically coupled communication with the latch mechanism, with the emergency backup mechanism being actuatable to move the pawl from the ratchet holding position to the ratchet releasing position without assistance from the power release mechanism.

In accordance with another aspect of the present disclosure, the emergency backup mechanism is accessible via an access opening in an inner door panel of the vehicle door, wherein the access opening can be covered by the inside door handle, wherein the access opening is exposed for access to the emergency backup mechanism by moving the inside door handle from the rest position, beyond the first deployed position, to a second deployed position.

In accordance with another aspect of the present disclosure, there is provided a latching system for a vehicle door having a latch with a pawl and a ratchet, and a backup release mechanism having one of a mechanical release mechanism mechanically coupled with the latch and an electrical release mechanism electrically coupled with the latch, and a moveable cover for concealing the backup release mechanism, where the pawl is adapted to release the ratchet in response to the opening of the cover and the backup release mechanism.

In accordance with another aspect of the disclosure, a method of constructing a closure latch system for a vehicle door is provided. The method includes a step of configuring a latch mechanism including a ratchet moveable between a striker capture position and a striker release position and a pawl moveable between a ratchet holding position, whereat the pawl holds the ratchet in the striker capture position and a ratchet releasing position whereat the pawl permits the ratchet to move to the striker release position. Further, a step of configuring a power release mechanism having a home position, a lock position, and a child lock position; and a step of configuring an inside door handle in operable communication with the power release mechanism with the inside door handle having a rest position, a first deployed position and a second deployed position. While the power release mechanism is in the home position, the pawl moves from the ratchet holding position to the ratchet releasing position under power of the power release mechanism in response to a single actuation of the inside door handle from the rest position to the first deployed position, and while the power release mechanism is in the lock position, the pawl does not move from the ratchet holding position to the ratchet releasing position under power of the power release mechanism in response to a single actuation of the inside door handle from the rest position to the first deployed position.

In accordance with a further aspect of the method, a step includes configuring the closure latch system such that while power release mechanism is in the lock position, the pawl moves from the ratchet holding position to the ratchet releasing position under power of the release mechanism in response to a double actuation of the inside door handle by moving the inside door handle from the rest position to the first deployed position, twice in succession.

In accordance with a further aspect of the method, a step includes configuring the closure latch system such that while the power release mechanism is in the child lock position, the pawl cannot be moved from the ratchet holding position to the ratchet releasing position by actuation of the inside door handle.

In accordance with a further aspect of the method, a step includes configuring an emergency backup mechanism in mechanically coupled communication with the latch mechanism, with the emergency backup mechanism being actuatable to move the pawl from the ratchet holding position to the ratchet releasing position without assistance from the power release mechanism while the power release mechanism is in any one of the home position and the lock position.

In accordance with a further aspect of the method, a step includes configuring the emergency backup mechanism to be made accessible via an access opening in an inner door panel of the vehicle door.

In accordance with a further aspect of the method, a step includes concealing the access opening with the inside door handle, wherein the access opening is exposed for access to the emergency backup mechanism by moving the inside door handle from the rest position to the second deployed position. It is to be recognized that the access opening is intended to be inaccessible during normal use, and is further intended to be inconspicuous, such that the aesthetic appearance of the inside door handle region is pleasing. It is only when desired, such as during an emergency, including a power shortage to power release mechanism, that the access opening is intended to be exposed for access to the emergency backup mechanism, as will be understood by a person skilled in the art upon viewing the disclosure herein.

In accordance with a further aspect of the method, a step includes configuring the inside door handle in electrical communication with the power release mechanism, such that the only communication between the inside door handle and the latch mechanism can be made electrical, and not mechanical.

Further areas of applicability will become apparent from the description provided herein. As noted, the description and any specific examples in this summary are intended for purposes of illustration only and are not intended to limit the scope of the present disclosure.

### BRIEF DESCRIPTION OF THE DRAWINGS

The drawings described herein have been provided to illustrate selected embodiments and specific features thereof and are not intended to limit the scope of the present disclosure. The present disclosure will now be described by way of example only with reference to the attached drawings, in which:

FIG. 1 is an isometric view of a motor vehicle having vehicle door equipped with a closure latch assembly constructed in accordance with multiple aspects of the disclosure;

FIG. 2 is an isometric view of a closure latch assembly constructed in accordance with one aspect of the disclosure for use in the vehicle door shown in FIG. 1 shown arranged for receipt of a striker therein;

FIG. 3A is a rear-side isometric view showing a release mechanism and some internal components of a latch mechanism of the closure latch assembly of FIG. 2 shown in a Latched mode;

FIG. 3B is a front-side isometric view of the release mechanism and latch mechanism of FIG. 3A;

FIG. 4 is an end plan view of the closure latch assembly showing a child lock toggle moved from a deactivated position (phantom) to an activated position (solid);

FIG. 5A is an exploded view illustrating a reaction chain connection between a child lock feature and a closure latch assembly operably connected to an inside door handle, with the child lock feature shown in a child lock OFF position;

FIG. 5B is a side view of the child lock feature shown in a child lock ON position;

FIG. 6 is a flow diagram illustrating a closure latch system in accordance with one aspect of the disclosure;

FIG. 7 is a flow diagram illustrating a closure latch system in accordance with another aspect of the disclosure;

FIGS. 8-15 illustrate aspects and operation of the closure latch assembly and closure latch system therewith in accordance with various aspects of the disclosure;

FIGS. 16-26 illustrate further aspects and operation of a closure latch assembly and closure latch system therewith in accordance with additional aspects of the disclosure;

FIGS. 27, 27A and 28 illustrate an emergency backup mechanism of a closure latch system in accordance with a further aspect of the disclosure;

FIG. 29 is a flow diagram illustrating a closure latch system in accordance with a further aspect of the disclosure;

FIG. 30 is a flow diagram illustrating a closure latch system in accordance with yet another aspect of the disclosure;

FIG. 31 is an isometric view of a motor vehicle having vehicle door equipped with a closure latch assembly constructed in accordance with another aspect of the disclosure;

FIG. 32 is a schematic view of the bracketed region 32 of FIG. 31 illustrating operable communication between an inside actuation assembly and a closure latch assembly of a closure latch system with normal and emergency backup mechanisms being provided in accordance with a further aspect of the disclosure;

FIG. 33 is a view similar to FIG. 32 illustrating a sequence of a normal release of the closure latch assembly via selective movement of an inside handle of the inside actuation assembly;

FIG. 34 is a view similar to FIG. 32 illustrating a sequence of an emergency release of the closure latch assembly via selective movement of an emergency release member of the inside actuation assembly;

FIG. 35 is a schematic illustration showing closure latch system during a normal release condition via actuation of an inside release mechanism while in a lock OFF, child lock OFF position corresponding to FIGS. 19-21 and FIG. 33;

FIG. 35A is a schematic illustration of closure latch system of FIG. 35 showing a controller in operable communication with the inside release mechanism;

FIG. 35B illustrates a power release gear of the closure latch system of FIGS. 35 and 35A;

FIG. 36 is a view similar to FIG. 35 showing closure latch system during a deactivated, decoupled condition while in a lock ON, child lock ON position corresponding to FIGS. 23-24;

FIG. 36A is a schematic illustration of closure latch system of FIG. 36 showing a controller in operable communication with the inside release mechanism;

FIG. 36B illustrates a power release gear of the closure latch system of FIGS. 36 and 36A;

FIG. 37 is a view similar to FIG. 35 showing closure latch system during an emergency release condition while in a lock ON, child lock OFF position;

FIG. 37A is a schematic illustration of closure latch system of FIG. 37 showing a controller in operable communication with the inside release mechanism;

FIG. 37B illustrates a power release gear of the closure latch system of FIGS. 37 and 37A; and

FIG. 38 is a flow diagram illustrating a method of constructing a closure latch system for a vehicle door in accordance with a further aspect of the disclosure.

### DETAILED DESCRIPTION OF EXAMPLE EMBODIMENTS

Example embodiments of a closure latch for use in motor vehicle door closure systems are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

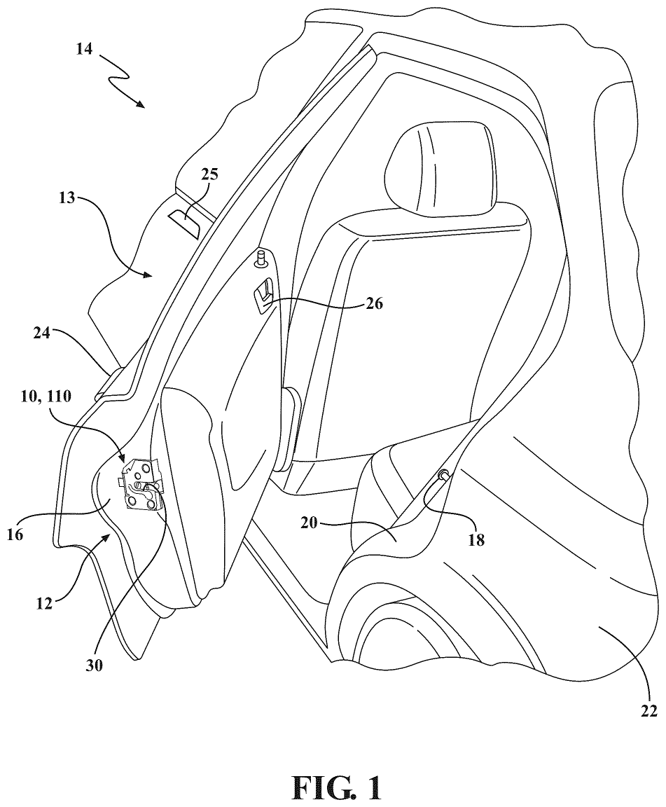

Referring initially to FIG. 1, a closure latch assembly, also referred to as closure latch or latch assembly 10, for a closure panel, such as a swing door, shown as a rear door 12, by way of example and without limitation, of a motor vehicle 14 is shown positioned along a shut face portion 16 of door 12 and is configured to releasably engage and capture a striker 18 secured to a vehicle body 22 to extend within a door opening 20 formed in vehicle body 22 in response to movement of door 12 from an open position to a closed position. Door 12 is shown to include an outside door handle 24 and an inside door handle 26, both of which are operatively connected (i.e., electrically and/or mechanically) to closure latch assembly 10. While not shown, it is understood that a similar closure latch assembly is provided in association with a front door 13 of vehicle 14 shown to include its own outside door handle 25.

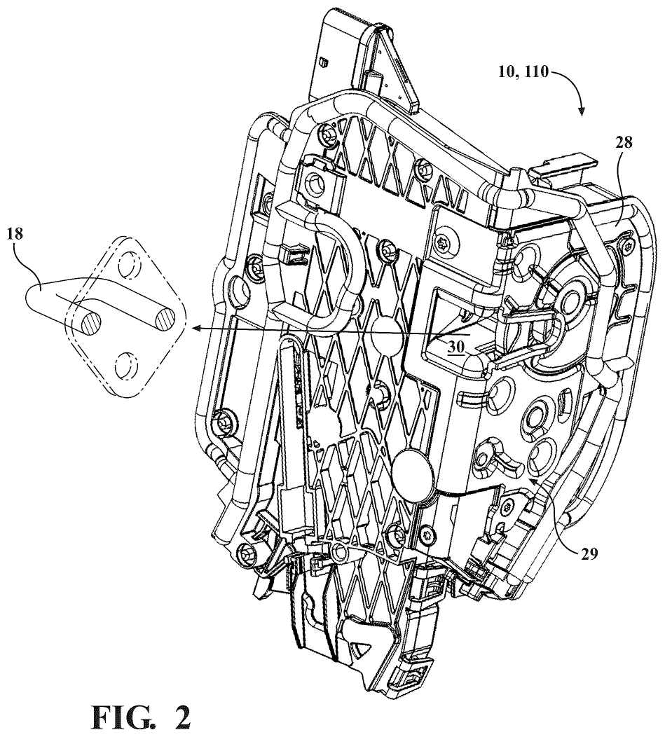

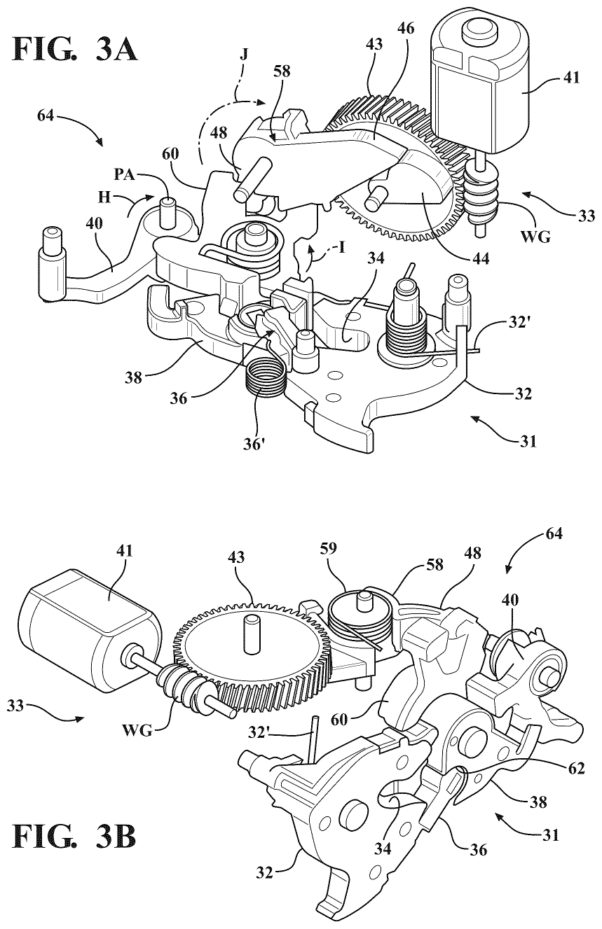

Referring now to FIGS. 2-3B, a non-limiting example embodiment of closure latch assembly 10 and internal components thereof is shown to generally include a latch mechanism 31 and a power latch release mechanism, referred to hereafter simply as latch release mechanism 33 (FIGS. 3A and 3B). Latch mechanism 31 is shown, by way of example and without limitation, as a double pawl-double ratchet configuration, by way of example and without limitation, having a primary ratchet, also referred to as main ratchet 32, a primary pawl, also referred to as main pawl 36, a secondary ratchet, also referred to as auxiliary ratchet 38, and a secondary pawl, also referred to as auxiliary pawl 40. Primary ratchet 32 is pivotably mounted to a plate segment 28 of a latch housing 29 and has a ratchet slot 34 alignable with a fishmouth slot 30 (FIG. 2) formed in latch housing 29. Primary ratchet 32 is moveable between a primary closed or “striker capture” position whereat striker 18 is held within fishmouth slot 30 via being captured in ratchet slot 34, and an open or “striker release” position whereat striker 18 is free to be released from ratchet slot 34 and fishmouth slot 30. Primary ratchet 32 is biased by a primary ratchet biasing member, such as a primary ratchet spring 32′ (FIGS. 3A and 3B) toward its striker release position. Primary pawl 36 is shown, by way of example and without limitation, pivotably supported by secondary ratchet 38 for movement between a secured, primary ratchet locking position, also referred to as “closed” position, whereat primary pawl 36 locates and holds primary ratchet 32 in its striker capture position, and an unsecured, primary ratchet release position, also referred to as “open” position, whereat primary pawl 36 is positioned to permit primary ratchet 32 to move to its striker release position, such as under a bias imparted by primary ratchet spring 32′ on primary ratchet 32. A primary pawl biasing member, such as a primary pawl spring 36′, is operable to normally bias primary pawl 36 toward its open position. Secondary ratchet 38 is pivotably mounted to plate segment 28 of latch housing 29 for movement between a first or “engaged” position whereat secondary ratchet 38 holds primary pawl 36 in its closed position and a second or “disengaged” position whereat secondary ratchet 38 allows primary pawl 36 to be biased to its open position. A secondary ratchet biasing member (such as a spring member, not shown) is provided for normally biasing secondary ratchet 38 toward its engaged position. Finally, secondary pawl 40 is pivotably mounted to plate segment 28 to pivot about pivot axis PA for movement between an auxiliary ratchet locking position, also referred to as first or “closed” position, whereat secondary pawl 40 holds secondary ratchet 38 in its engaged position, and an auxiliary ratchet release position, also referred to as a second or “open” position, whereat secondary pawl 40 is positioned to permit secondary ratchet 38 to move to its disengaged position. A secondary pawl biasing member, such as a secondary pawl spring (not shown) is provided for normally biasing secondary pawl 40 toward its closed into engagement, or into a blocking position, with auxiliary ratchet 38.

Latch release mechanism 33 is best shown in FIGS. 3A and 3B to include a powered actuator, shown as a single electric motor 41, shown as including a motor shaft with a worm gear WG fixed thereto, and a power release gear 43 driven by worm gear WG of electric motor 41 which functions to drive an actuator release lever, also referred to as actuator lever 58 via engagement of a cam member 44 fixed to power release gear 43 with a first end region 46 of actuator lever 58, which in turn functions to drive a latch release lever, also referred to as release lever, and shown by way of example and without limitation as an auxiliary pawl release lever 60, via engagement of a second end region 48 of actuator lever 58 with auxiliary pawl release lever 60, which in turn moves secondary pawl 40 from its closed position to its open position to provide a power releasing function of latch mechanism 31.

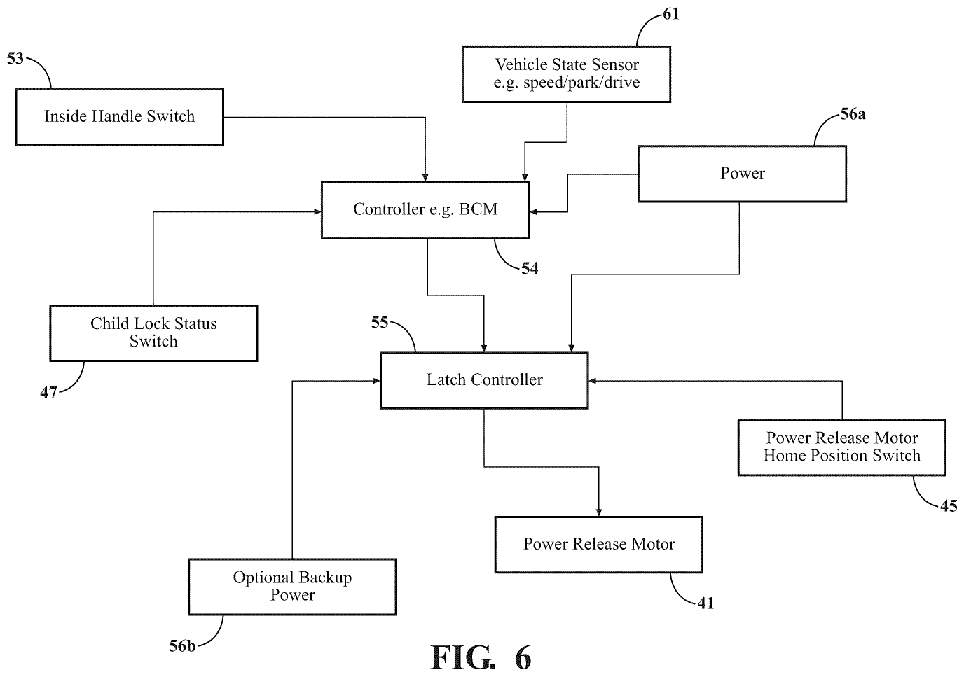

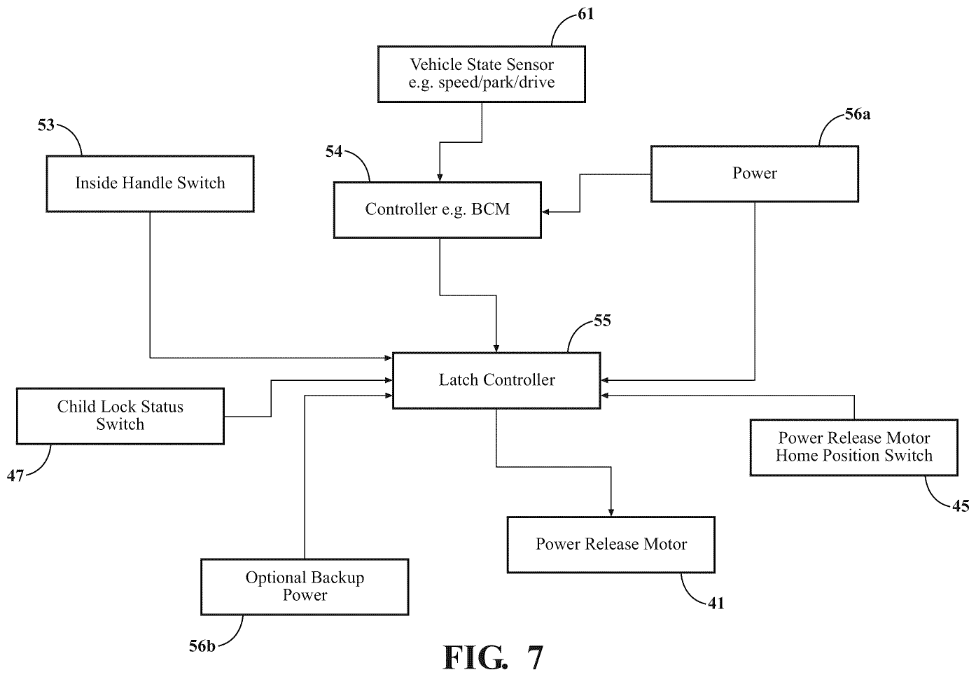

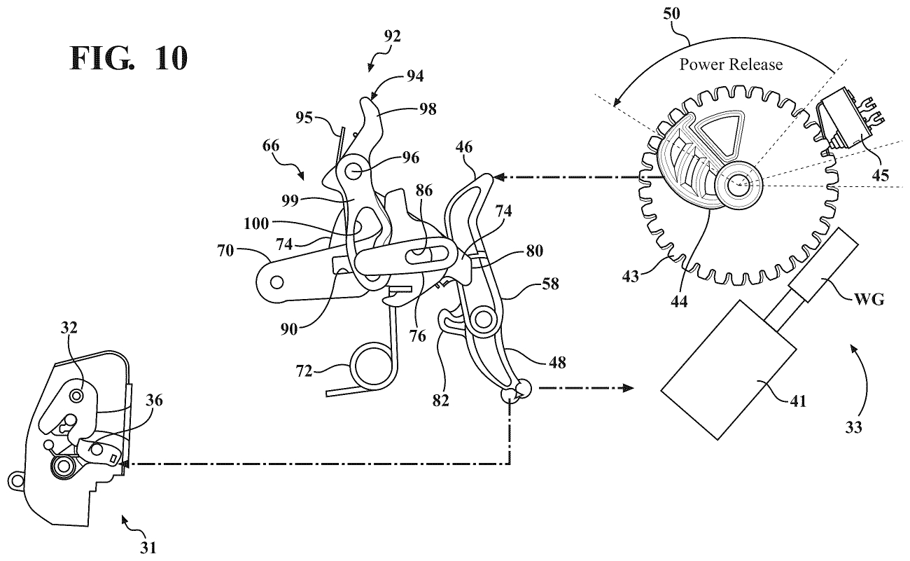

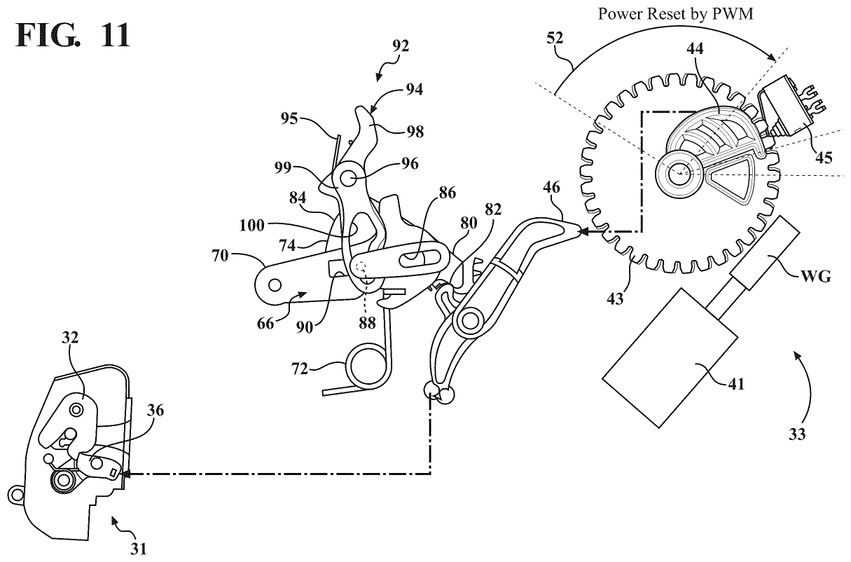

Rotation of power release gear 43 in a first or “releasing” direction 50 (FIG. 10) results in release of latch mechanism 31 via primary pawl 36 being moved to its ratchet releasing position and primary ratchet 32 being allowed to move to its striker releasing position, and rotation in an opposite or “resetting” direction 52 (FIG. 11) results in resetting of latch mechanism 31. The actuator release lever 58 is in direct or operable (chain connection) engagement with the auxiliary pawl release lever 60 while the auxiliary pawl release lever 60 is in a rest position and is moveable by the actuator 41 to move the auxiliary pawl release lever 60 to an engaged position. As is well known, a key fob or actuation of an inside handle switch 53 in operable communication with door handle 24, 25 on door 12, 13 can provide a signal to an electronic control unit (ECU) associated with closure latch assembly 10, such as shown via a controller in the form of a body control module (BCM) 54 and/or a latch controller 55 in FIG. 6, indicating a request to release latch mechanism 31. Accordingly, the ECU and/or latch controller 54, 55 controls operation of motor 41 to rotate power release gear 43. Any suitable main and backup power source 56a, 56b may be provided for operable communication with ECU and/or latch controller 54, 55. Also shown in FIG. 6 is a child lock status switch 47 and power release motor home position switch 45 configured in operable communication with latch controller 55, and a vehicle state sensor 61 configured in operable communication with ECU 54, by way of example and without limitation. In another embodiment, shown in FIG. 7, the inside handle switch 53 and the child lock status switch 47 are shown configured in operable communication with latch controller 55, otherwise, the embodiment of FIG. 7 is the same as shown for FIG. 6.

Auxiliary pawl release lever 60 is coupled with the auxiliary pawl 40, and as shown illustratively in FIGS. 3A and 3B, is biased into direct engagement with auxiliary pawl 40 via counteracting biasing members, represented by arrow H acting on auxiliary pawl 40 (FIG. 3A), and auxiliary pawl release lever 60 is coupled with the auxiliary ratchet 38, and is shown as being biased into direct engagement with auxiliary ratchet 38 via counteracting biasing members, represented by arrow “I” acting on auxiliary pawl release lever 60 (FIG. 3A). Auxiliary pawl release lever 60 is further biased in addition to spring member I by the engagement of the actuator release lever 58 under bias indicated by arrow “J” shown in FIG. 3A of actuator release lever bias spring 59. Auxiliary pawl release lever 60 is moveable between a rest position, whereat the auxiliary pawl 40 is located in its closed position and the primary pawl 36 is located in its closed position, and a fully engaged position, whereat the auxiliary pawl 40 is moved to its open position and the primary pawl 36 is moved to its open position.

Auxiliary ratchet 38 is operably coupled to the primary pawl 36, wherein primary pawl 36 is shown retained for pivotal movement in a cylindrical pocket 62 of auxiliary ratchet 38. Auxiliary ratchet 38 is moveable between its engaged position, whereat the auxiliary ratchet 38 maintains the primary pawl 36 in its closed position, and its disengaged position, whereat the auxiliary ratchet 38 moves the primary pawl 36 to its open position, as discussed above. Auxiliary ratchet 38 is moved to its disengaged position against bias of spring bias, the auxiliary pawl 40 is forcibly moved to its open position against the spring bias under the driving influence of auxiliary pawl release lever 60 and actuator release lever 58, that is due to the driving influence of actuator release lever 58 moved against spring bias J and acting on auxiliary pawl release lever 60 when power release gear 43 is rotated in the release direction 50 to a release position.

The single motor 41, in association with a release chain 64 and a double pull mechanism 66 having a single pull state and a double pull state, operates to perform a select one of: power release the latch assembly 10, put the latch mechanism 31 of latch assembly 10 in a single pull state, and put the latch mechanism 31 of latch assembly 10 in a double pull state. Operation and logic flow of the closure latch assembly 10 is shown in 8-15, and discussed in more detail hereafter.

The release chain 64 includes latch mechanism 31, including actuator release lever 58 and auxiliary pawl release lever 60. It is to be understood that latch mechanism 31 is illustrated and described having a double pawl/double ratchet mechanism; however, a single pawl/single ratchet mechanism is contemplated herein. The single motor 41 is actuatable to move the double pull mechanism 66 to one of its single pull state and double pull state, wherein activation of the single motor 41 operates to perform a select one of: power release the latch assembly 10 via release chain 64, put the double pull mechanism 66 of latch assembly 10 in the single pull state, and put the double pull mechanism 66 of latch assembly 10 in the double pull state.

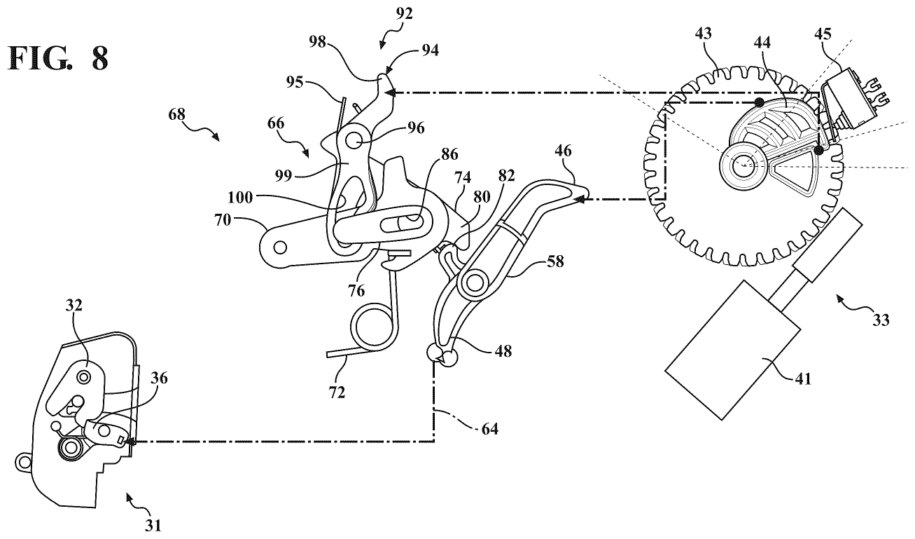

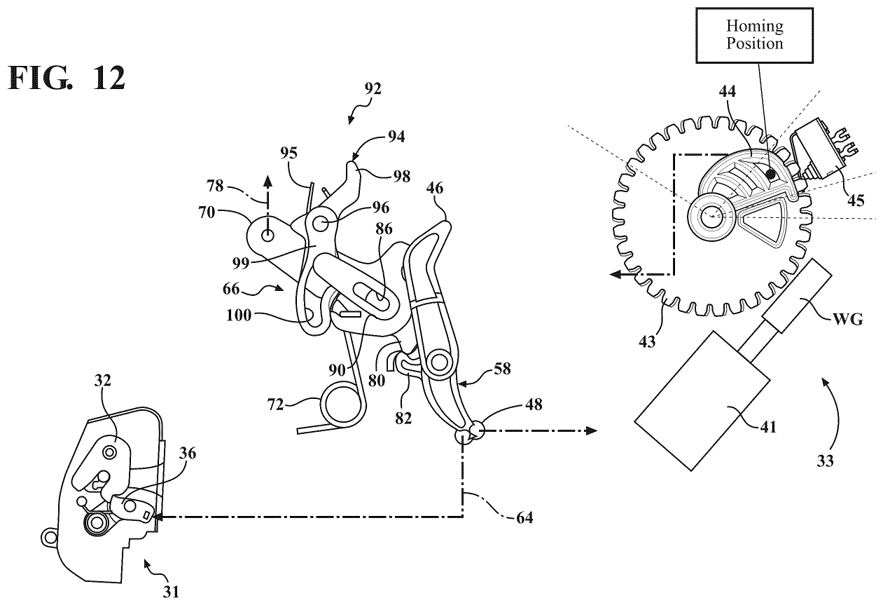

FIG. 8 is a non-limiting embodiment of an inside release mechanism 68 that is operatively associated with power latch release mechanism 33 for use with closure latch assembly 10. Inside release mechanism 68 is shown to include an inside release lever 70 that is pivotably moveable between a first or “home” position (shown) and a second or “actuated” position (FIG. 12), an inside release lever spring 72 operable to normally bias inside release lever 70 to its home position, an auxiliary release lever 74 (FIGS. 10 and 11) and a link lever 76. Inside release lever 70 is mechanically connected via a suitable coupling mechanism 78 (FIG. 12) to inside door handle 26. Inside release lever 70 is supported for pivotal movement relative to a post (not shown) between a first or “home” position and a second or “actuator lever release” position. Auxiliary release lever 74 is biased toward its home position via actuator lever spring acting thereon. Auxiliary release lever 74 is formed to include an actuation lug 80 that is engageable with a release lug 82 formed on actuator release lever 58, and a slotted portion defining a bypass cavity (hidden) and a drive lug 84. Link lever 76 includes an elongated slot 86 and a guide post 88 that is retained for sliding movement within a drive slot 90 formed in inside release lever 70. Guide post 88 on link lever 76 is aligned with bypass cavity (not shown) in auxiliary release lever 74 when link lever 76 is located in a first or “disengaged/retracted” position. In contrast, guide post 88 is aligned with drive lug 84 on auxiliary release lever 74 when link lever 76 is located in a second or “engaged/extended” position. As will be detailed, movement of inside release lever 70 between its home and actuated positions, in cooperation with movement of link lever 76 between its disengaged and engaged positions, controls selective pivotal movement of auxiliary release lever 74 between its home position and its actuator lever release position.

A double pull actuation mechanism 92 is arranged in operative association with inside release mechanism 68 for use with closure latch assembly 10. Double pull actuation mechanism 92 is shown to generally include a double pull lever 94, and a double pull lever spring 95. Double pull lever 94 is pivotably moveable about a pivot post 96 between a first or “double pull-ON” position and a second or “double pull-OFF” position. Double pull lever spring 95 acts on double pull lever 94 and normally biases double pull lever 94 toward its double pull-OFF position. Double pull lever 94 includes a first leg segment 98 and a second leg segment 99, with the second leg segment 99 having a contoured drive slot 100. As seen, second leg segment 99 is disposed between link lever 76 and inside release lever 70 such that guide post 88 on link lever 76 passes through drive slot 100 in double pull lever 94 and drive slot 90 in inside release lever 70.

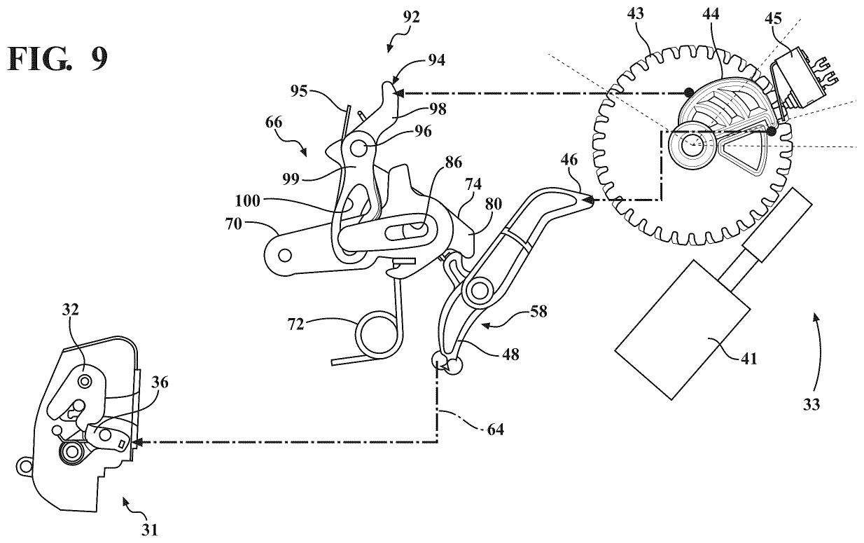

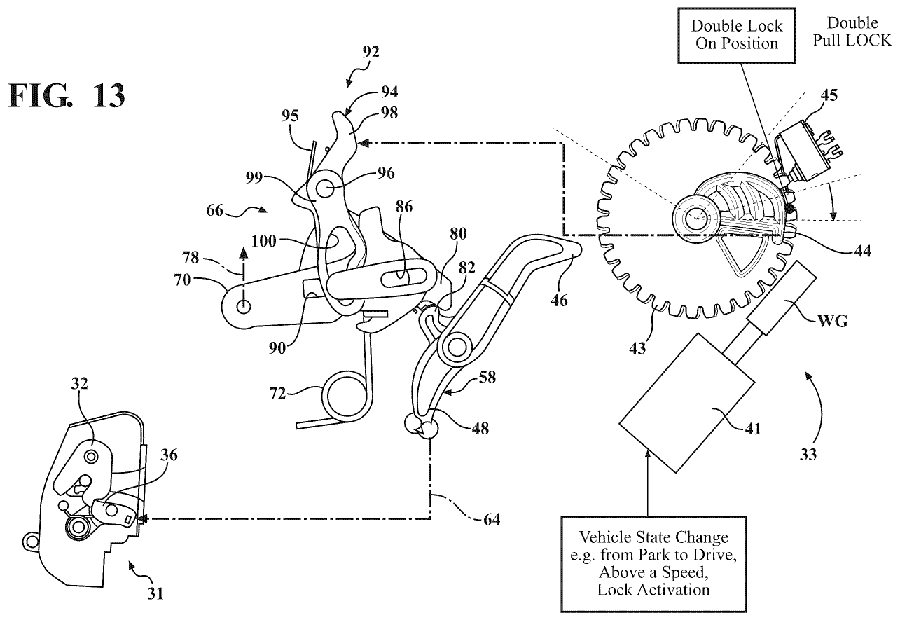

Power release mechanism 33 and power release gear 43 thereof is moveable by the single actuator 41 between a home position (FIG. 9), whereat power release gear 43 can be sensed via a home position sensor/switch, also referred to as first sensor 45, such that a switch that can be triggered by cam member 44, by way of example and without limitation, when power release gear 43 is in its home position, whereat the pawl 36 can be moved from the ratchet holding position to the ratchet releasing position upon a single actuation of the power release mechanism 33 or upon a single actuation of an inside handle 26, and a double pull lock position, also referred to as double pull or double lock position (FIG. 13), whereat the pawl 36 cannot be moved from the ratchet holding position to the ratchet releasing position upon a single actuation of the power release mechanism 33 or upon a single actuation of an inside handle 26. While the power release mechanism 33 is in the double pull lock position, the pawl 36 can only be moved from the ratchet holding position to the ratchet releasing position upon performing a double actuation of the power release mechanism 33, wherein the power release mechanism 33 moves directly from the double pull lock position to the release position upon performing the double actuation of the power release mechanism 33, or upon performing a double actuation of the inside handle 26, otherwise, the pawl 36 will remain in its ratchet holding position.

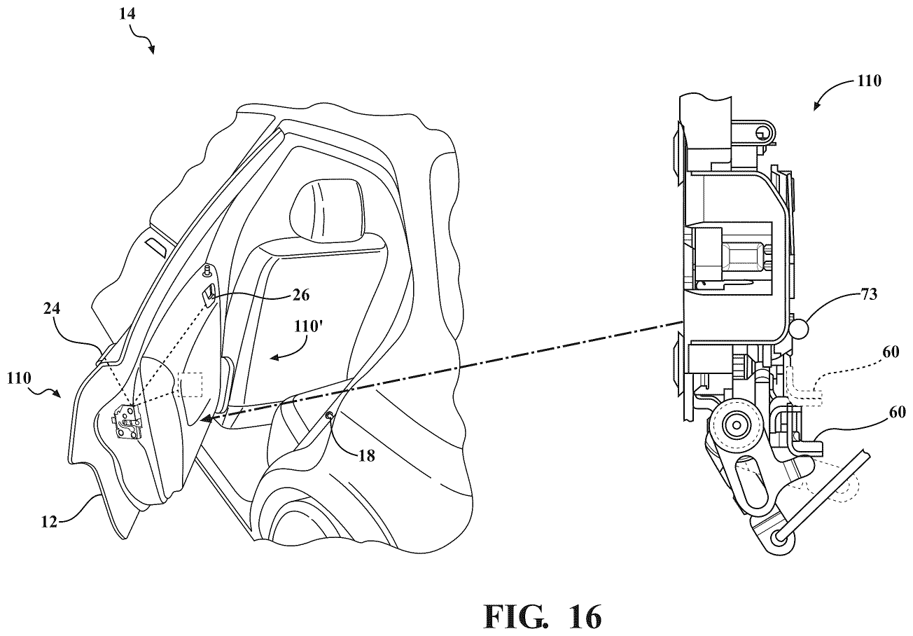

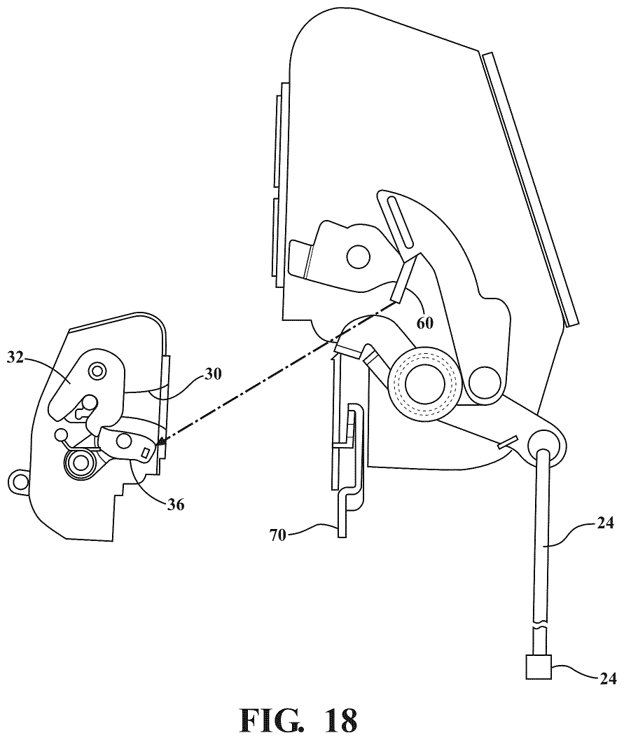

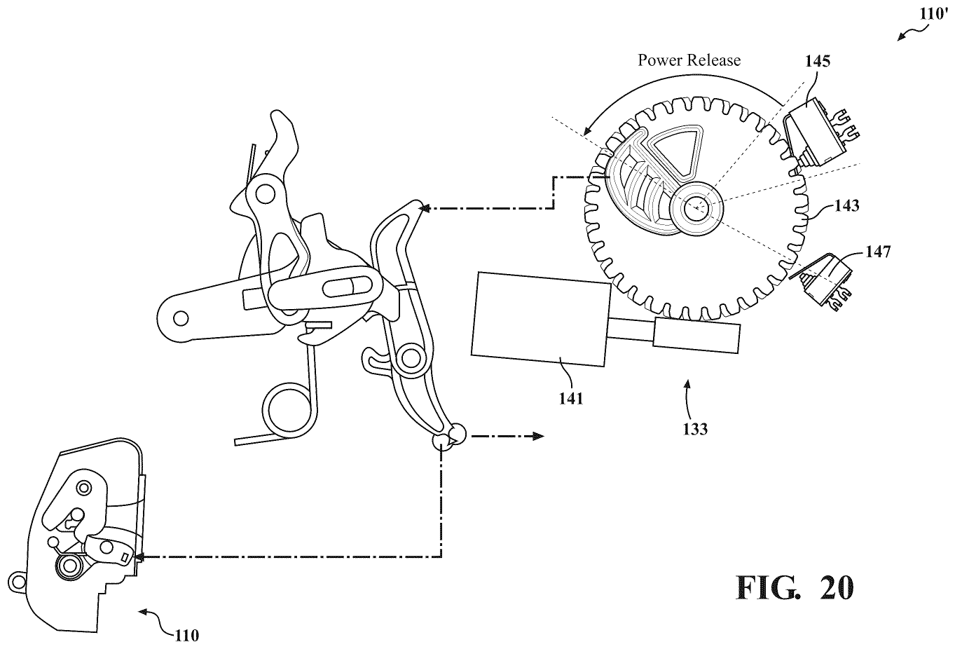

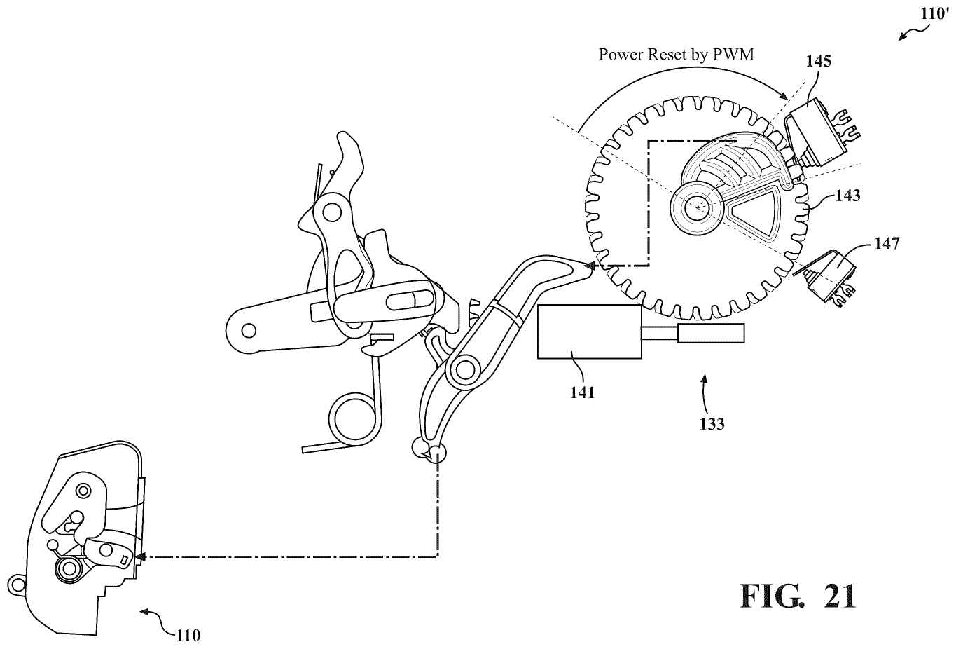

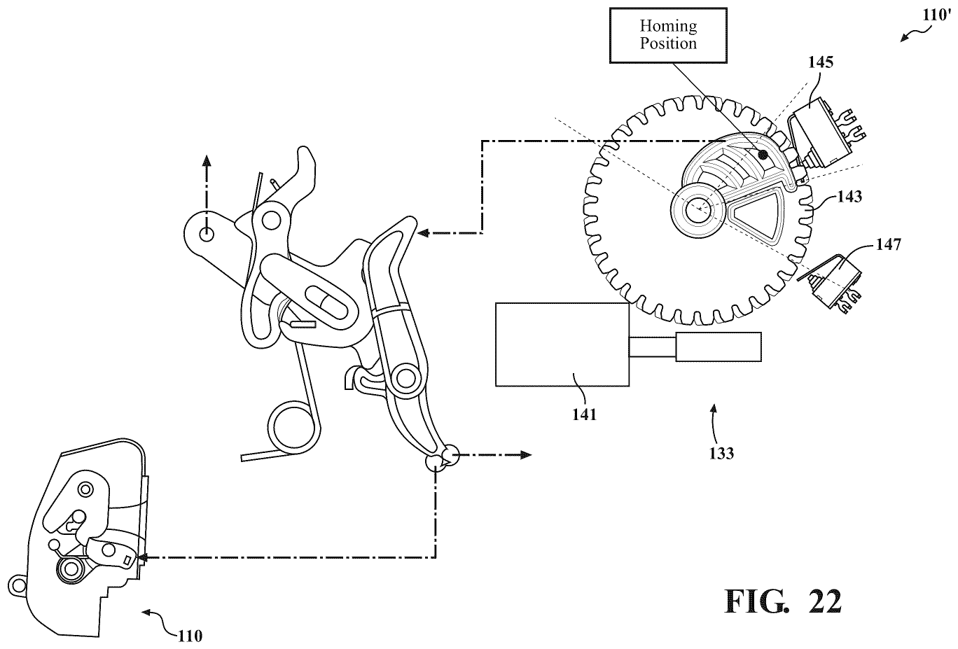

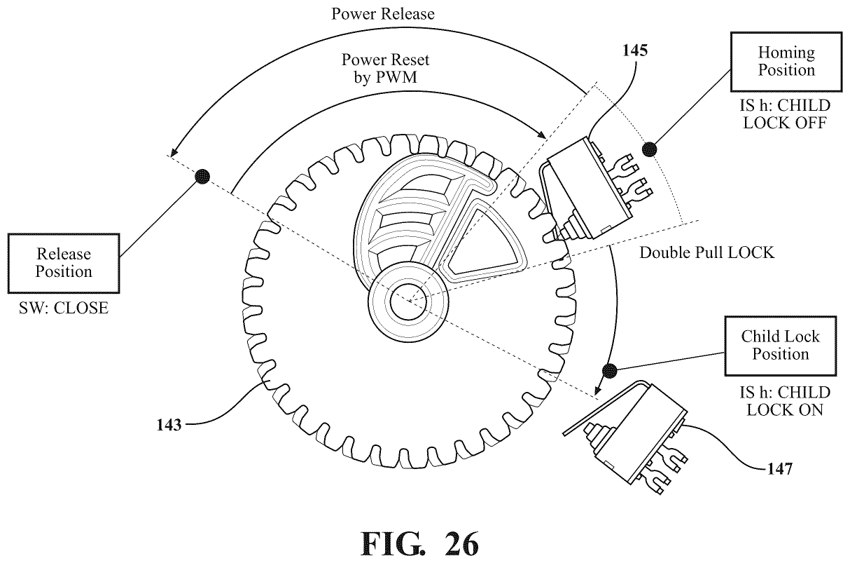

In accordance with another aspect of the disclosure, a closure latch assembly 110 and closure latch system 110′ therefor is shown in FIGS. 16-30, wherein the same reference numerals, offset by a factor of 100 in some instances, are used to identify like features.

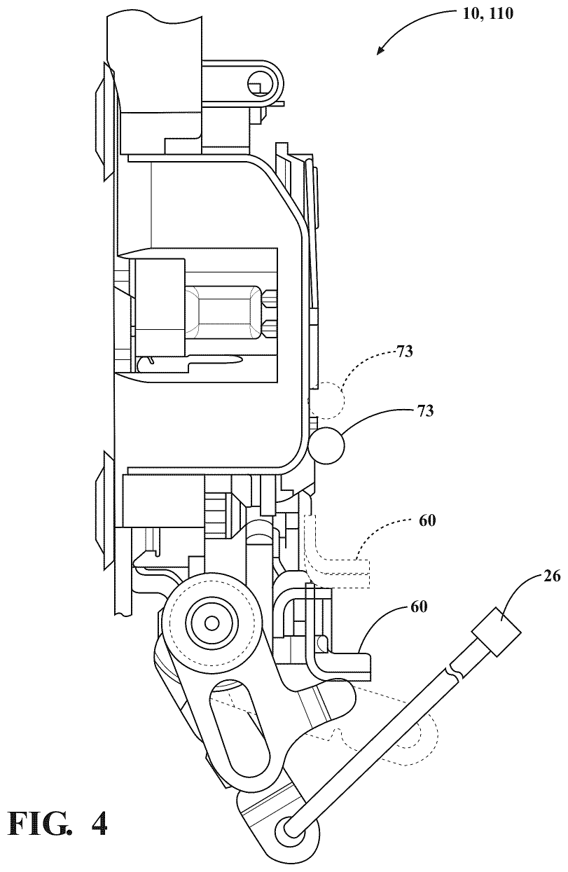

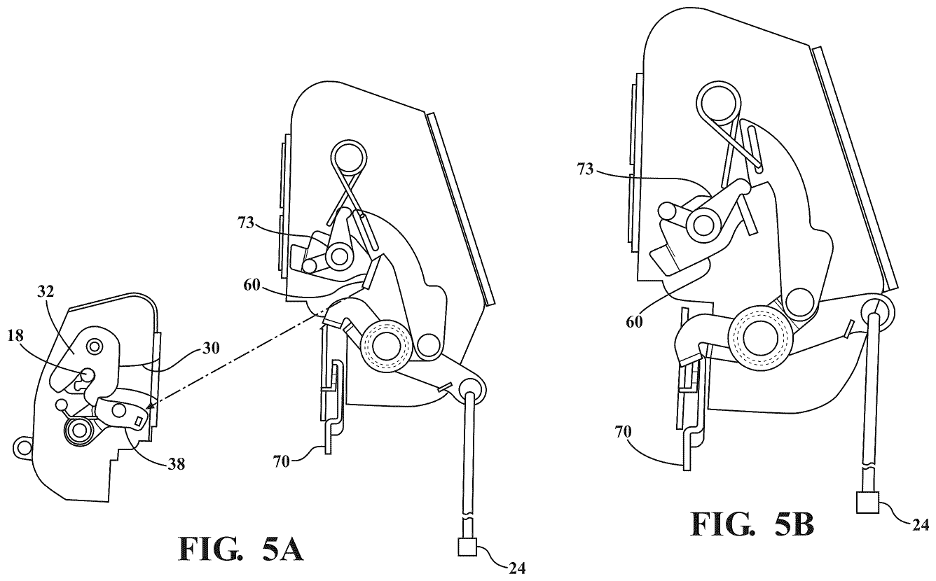

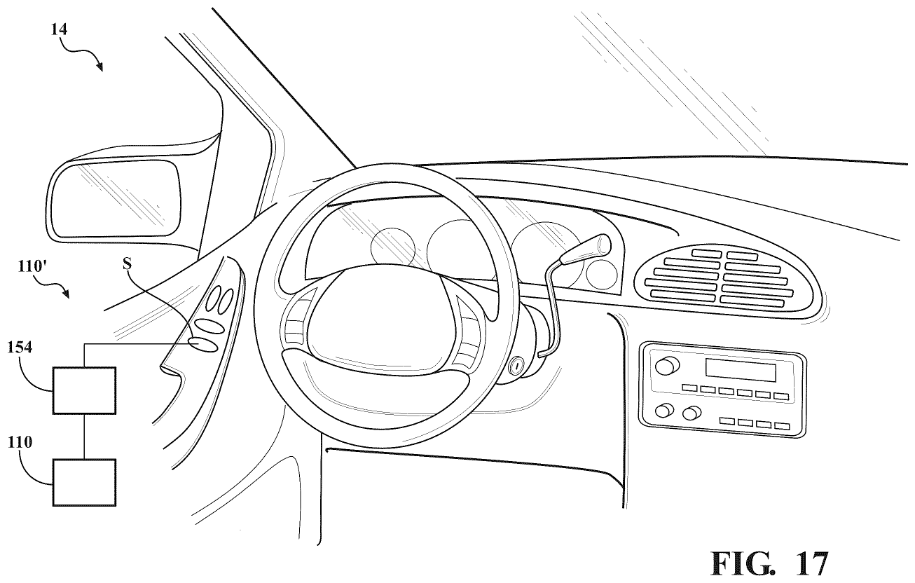

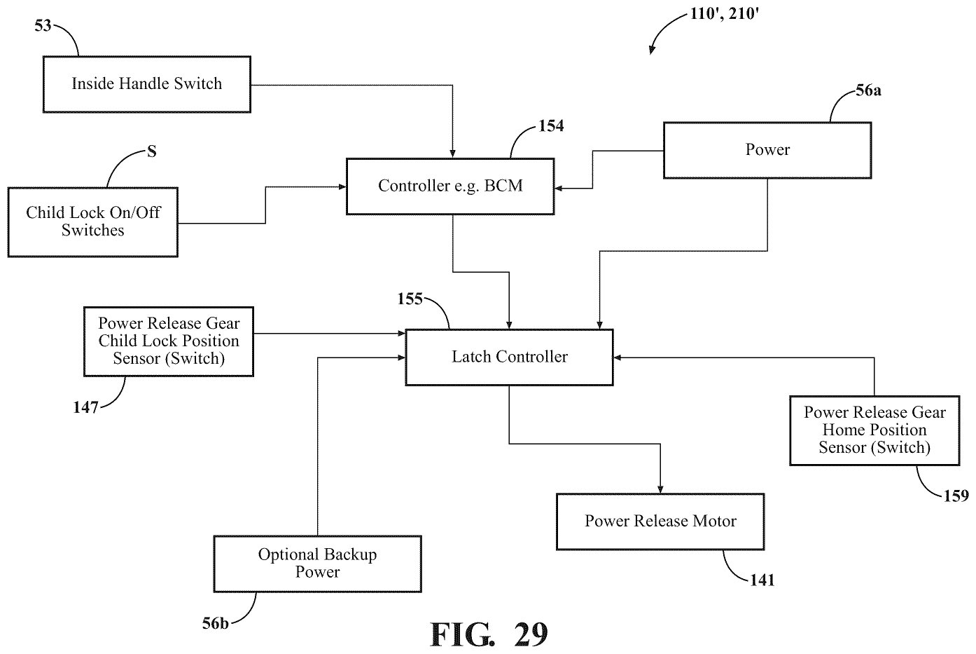

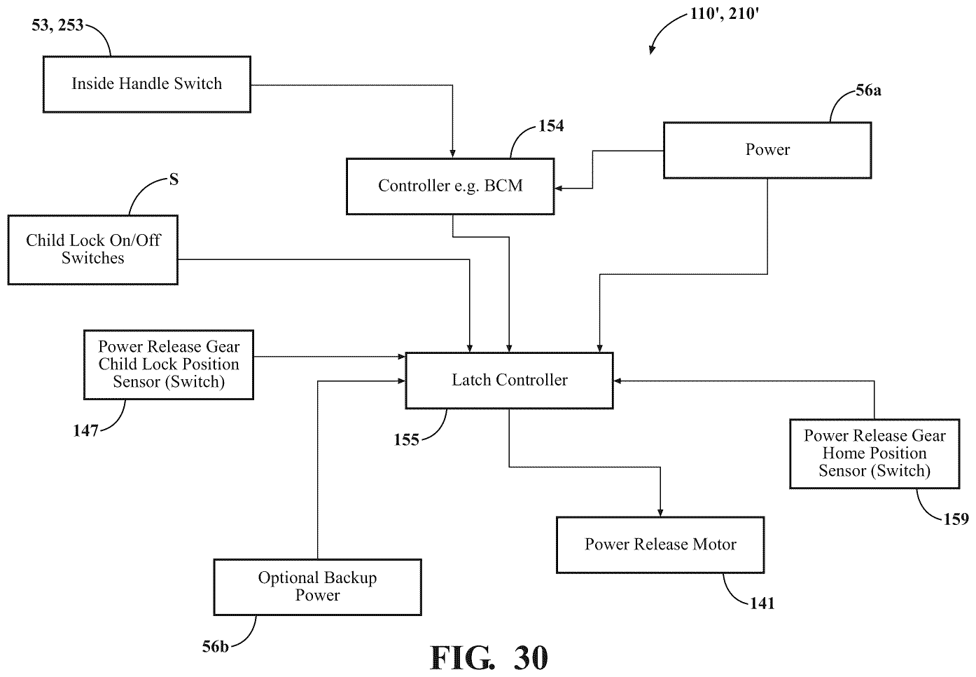

Closure latch system 110′ and closure latch assembly 110 thereof is shown in FIG. 16 as being configured for use on rear passenger door 12 of vehicle 14, by way of example and without limitation. Closure latch system 110′ includes a power-actuated child lock feature 73 (see also FIGS. 4, 5A and 5B) to selectively disable inside rear door handle 26 from being able to move closure latch assembly 110 from the latched state to the unlatched state while in a child lock ON position. Closure latch assembly 110 is the same or substantially the same as discussed above for closure latch assembly 10, and thus, repetition of discussion thereof is unnecessary, as one possessing ordinary skill in the art will readily understand the features and workings of closure latch assembly 110 without needless repetition. Power-actuated child lock feature can be selectively moved from a child lock OFF position (see also FIG. 5A), whereat rear door handle 26 is operable to move closure latch assembly 110 from the latched state to the unlatched state, to the child lock ON position (see also FIG. 5B). As shown in FIG. 17, a child lock button or switch S, shown as being accessible on an inner front door panel next to a front driver's seat, by way of example and without limitation, is operable to move the power-actuated child lock feature of the closure latch system 110′ and closure latch assembly 110 thereof between the child lock OFF position and the child lock ON position. Child lock switch S, as shown in FIG. 29, is configured in electrical communication with a controller (e.g. body control module BCM) 154, wherein BCM 154 can be configured in electrical communication with a latch controller 155, which can be configured in electrical communication with power actuator 141 of a power release mechanism 133, such as electrical motor, of closure latch assembly 110. As shown in FIG. 30, child lock switch S can be configured in direct electrical communication with latch controller 155, if desired.

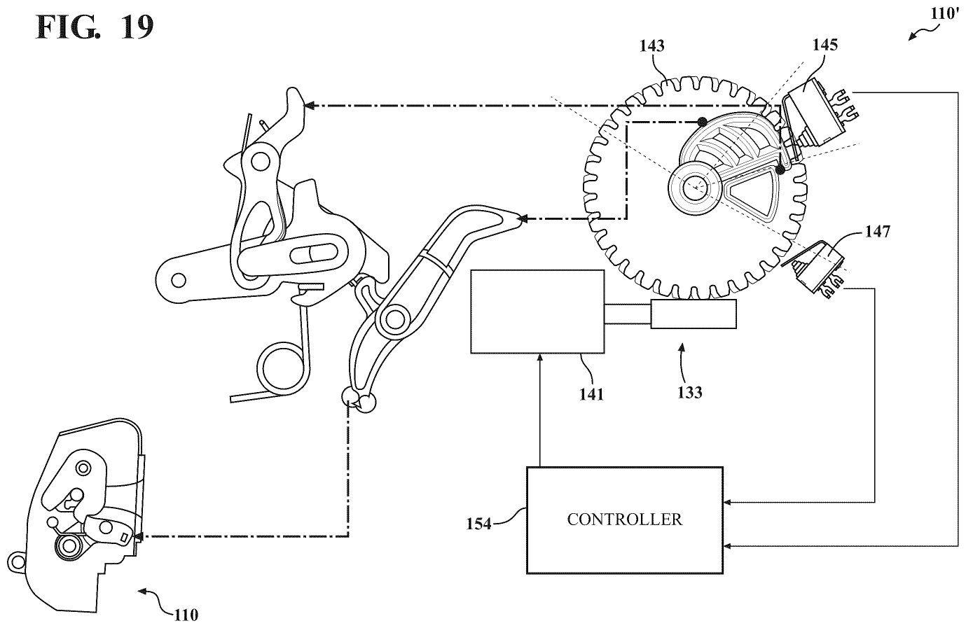

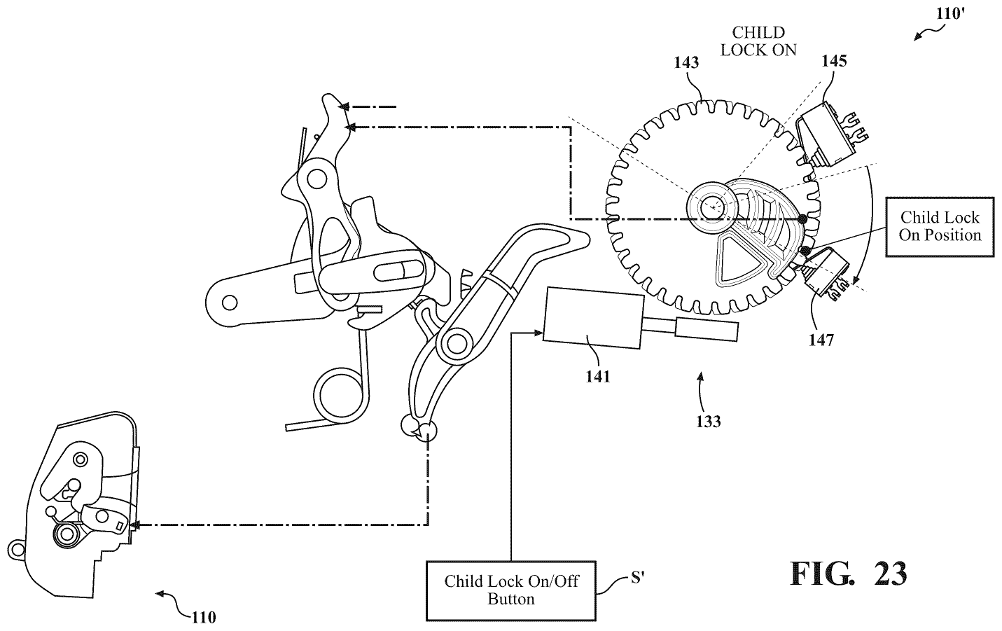

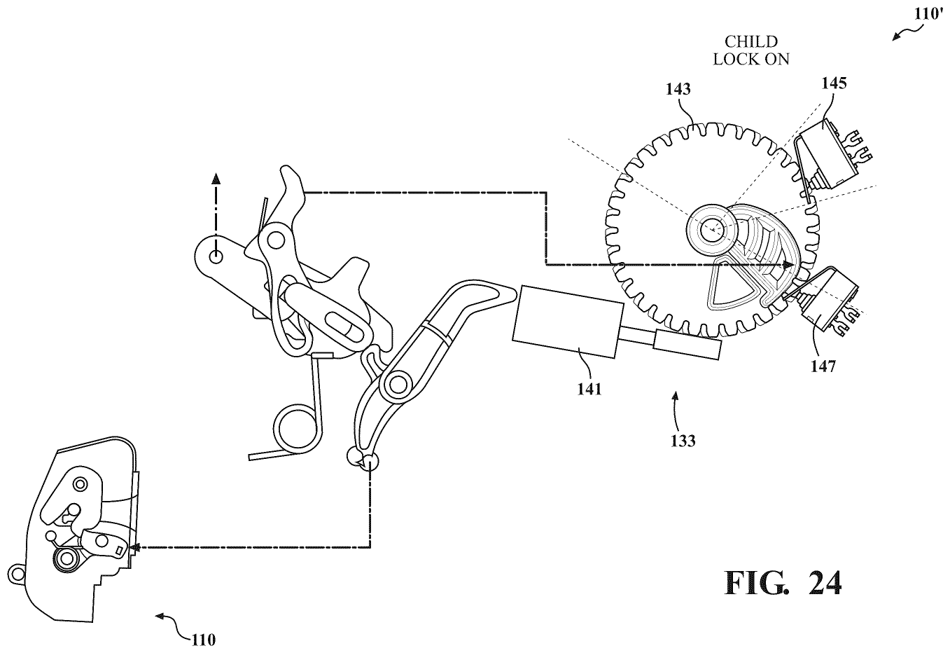

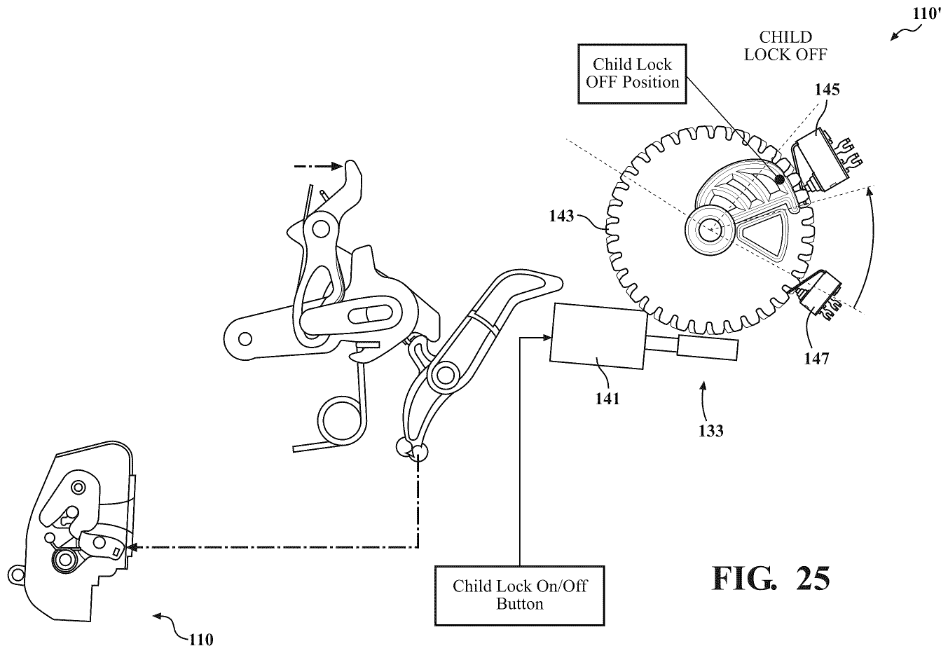

In FIGS. 19-26, various positions of power release gear 143 of power release mechanism 133 associated with power actuator 141 are shown. In FIGS. 19-22, the power-actuated child lock feature is in the child lock OFF position, whereat power release gear 143 can be sensed via a home position sensor/switch, also referred to as first sensor 145, such that a switch that can be triggered by cam member 144, by way of example and without limitation, when power release gear 143 is in its home position. In this position, the rear door handle 26 is operable to move the closure latch assembly 110 from the latched state to the unlatched state. In contrast, in FIGS. 23 and 24, power-actuated child lock feature is in the child lock ON position, whereat power release gear 143 can be sensed via a child lock position sensor/switch, also referred to as second sensor 147, such that a switch that can be triggered by cam member 144, by way of example and without limitation, when power release gear 143 is in its child lock position. In this position, the rear door handle 26 is inoperable to move the closure latch assembly 110 from the latched state to the unlatched state. Accordingly, rear door handle 26 is temporarily disconnected from electrical communication with power actuator 141, as long as power release gear 143 selectively remains in its child lock position, and thus, rear door handle 26 is unable to effect or otherwise command movement of the closure latch assembly 110 from the latched state to the unlatched state. As shown in FIG. 25, activation of the child lock switch S, such as by a driver sitting in a driver's seat, can drive power actuator 141 to move power-actuated child lock feature from the child lock ON position to the child lock OFF position, whereat rear door handle 26 is again operable to move the closure latch assembly 110 from the latched state to the unlatched state. Accordingly, rear door handle 26 is reconnected for electrical communication with power actuator 141, and thus, is able to effect and command movement of the closure latch assembly 110 from the latched state to the unlatched state.

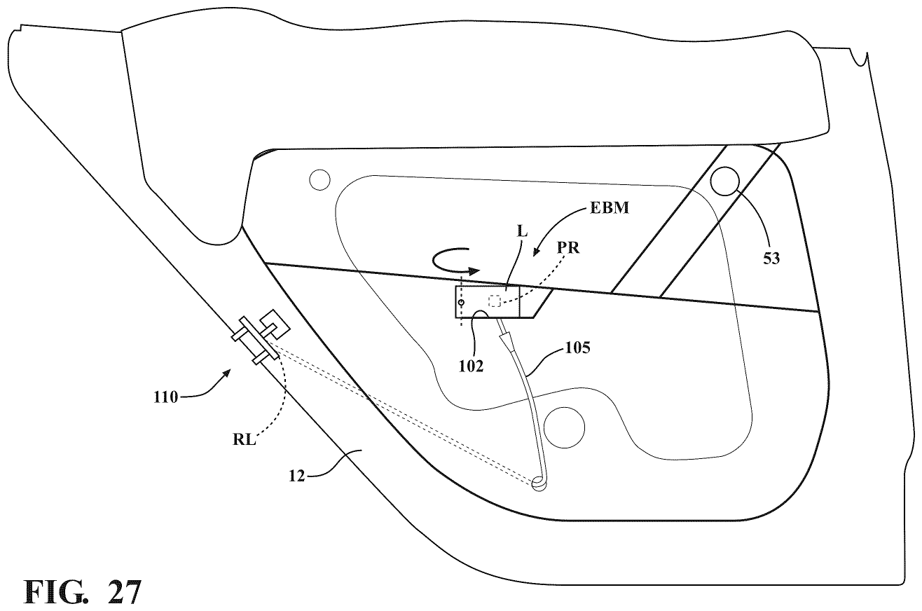

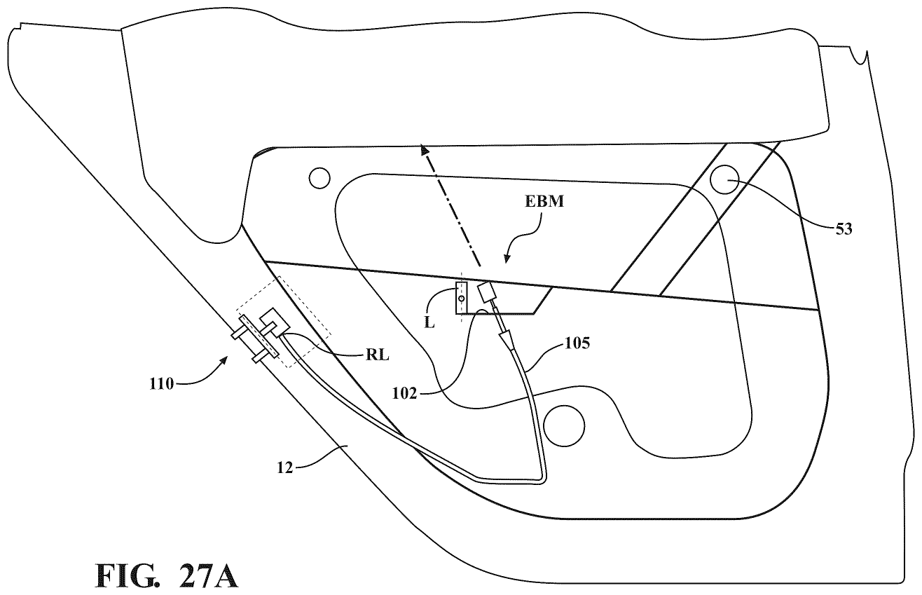

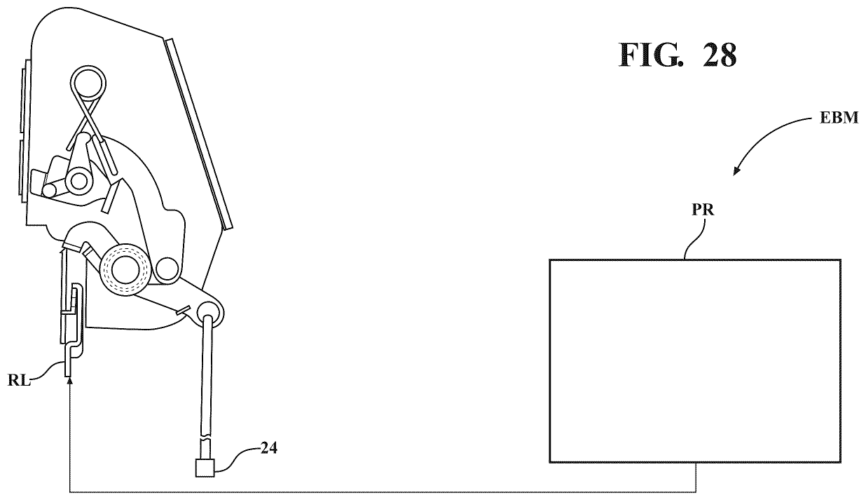

In FIGS. 27 and 27A, an emergency backup mechanism (EBM) is shown to provide an ability to mechanically move, without need of electrical power, the closure latch assembly 110 from the latched state to the unlatched state without assistance from the power actuator 141, thereby causing mechanically actuated movement of the pawl 36 from the ratchet holding position to the ratchet releasing position without assistance from the power actuator 141. As such, in the event power is inadvertently interrupted to power actuator 141, a passenger inside the motor vehicle 14 can gain access to the emergency backup mechanism EBM, such as via an access opening 102 covered by an emergency access cover, panel or lid L, to manually move closure latch assembly 110 from the latched state to the unlatched state. Lid L serves to prevent inadvertent access and mechanical actuation of closure latch assembly 110, such that an intention act of moving lid L from a closed position (FIG. 27) to an open position (FIG. 27A) is required to gain access to emergency backup mechanism EBM and intentionally actuate purely mechanical release of closure latch assembly 110. Emergency backup mechanism EBM includes an emergency mechanical release chain 164 configured to move pawl 36 from the ratchet holding position to the ratchet releasing position under purely mechanical actuatable linkage, rod and/or cable features. Emergency mechanical release chain 164 can be provided in a non-limitation embodiment by a handle, lever, pull tab, pull ring, or the like, illustrated as actuation member PR, attached to a cable 105, such as a Bowden cable, that is mechanically coupled to a release lever RL (FIG. 28) that is moveable to move pawl from the ratchet holding position to the ratchet releasing position, thereby causing latch assembly 110 to move from the latched state to the unlatched state. Accordingly, in a power-interrupted state, closure latch assembly 110 can be unlatched via manual actuation of emergency mechanical release chain 164, though closure latch assembly 110 is intended to be solely actuatable in “normal use” by inside handle 26 via powered actuation. As shown schematically in FIG. 16, outside door handle 24 can be configured for manual actuation via a Bowden cable.

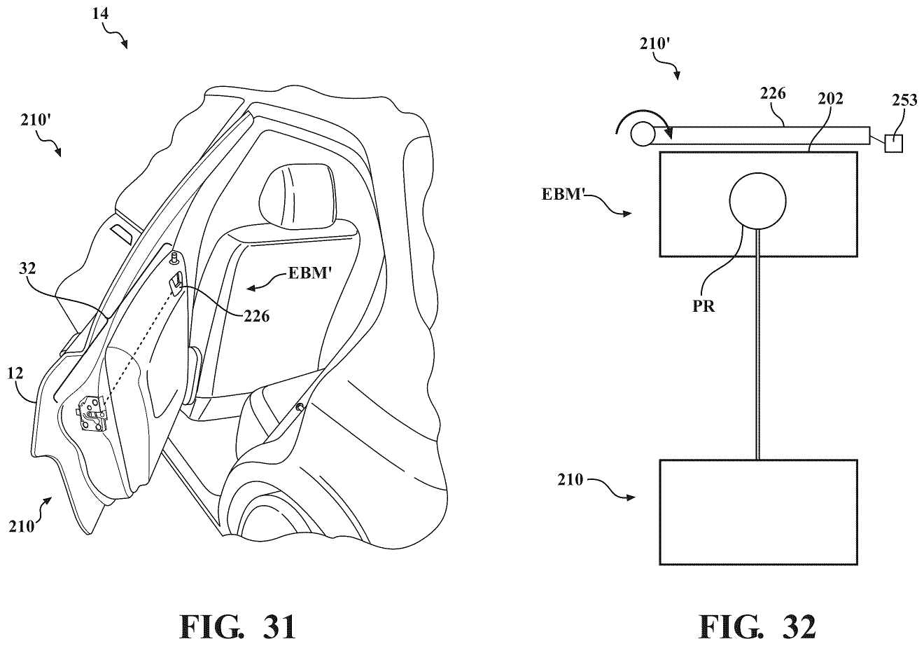

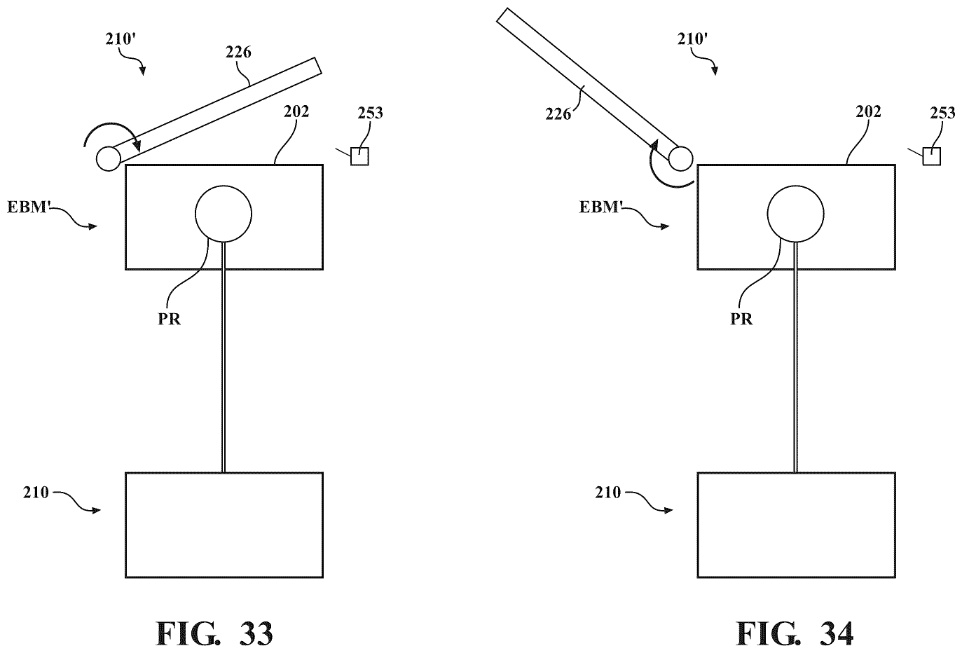

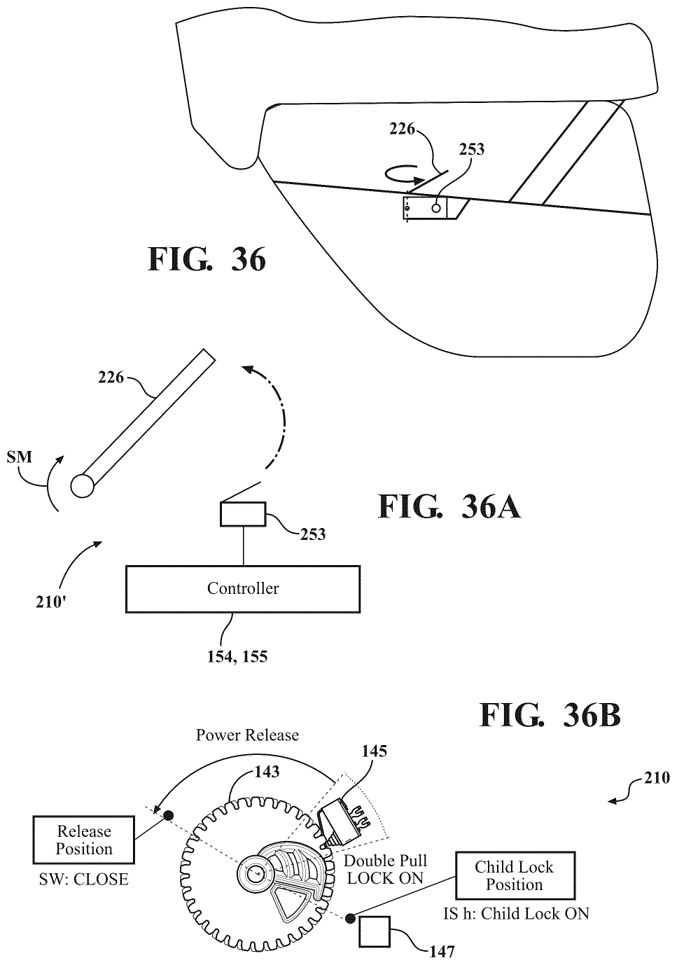

In FIG. 31, a closure latch system 210′ and closure latch assembly 210 thereof is shown configured for use on rear passenger door 12 of vehicle 14, by way of example and without limitation. Closure latch system 210′ includes a child lock feature to selectively disable an inside rear door release member, such as a rear door handle 226, from being able to move closure latch assembly 210 from a latched state to an unlatched state while in a child lock ON position. Closure latch system 210′ and closure latch assembly 210 thereof is the same or substantially the same as discussed above for closure latch assemblies 10, 110 and closure latch system 110′, and thus, repetition of discussion thereof is unnecessary, as one possessing ordinary skill in the art will readily understand the workings of closure latch system 210′ and closure latch assembly 210 without repetition. Power-actuated child lock feature can be selectively moved from a child lock OFF position (FIGS. 33, 35, and 37), whereat rear door handle 226 is operable to move closure latch assembly 210 from the latched state to the unlatched state, to the child lock ON position (FIG. 36), whereat rear door handle 226 is inoperable to move closure latch assembly 210 from the latched state to the unlatched state. As shown in FIG. 17, a child lock button or switch S, shown as being accessible on an inner front door panel next to a front driver's seat, by way of example and without limitation, is operable to move the power-actuated child lock feature of the closure latch system 210′ and closure latch assembly 210 thereof between the child lock OFF position and the child lock ON position. Child lock switch S, as shown in FIG. 29, is configured in electrical communication with a controller (e.g. body control module BCM) 154, wherein BCM 154 can be configured in electrical communication with a latch controller 155, which can be configured in electrical communication with power actuator 141 of a power release mechanism 133, such as electrical motor, of closure latch assembly 210. As shown in FIG. 30, child lock switch S can be configured in direct electrical communication with latch controller 155, if desired. Further, closure latch system 210′ is operable to move to a double lock position, also referred to as lock ON position, as shown and discussed for FIG. 13, and thus, no further discussion is believed necessary.

In FIGS. 32-33, an emergency backup mechanism (EBM′) is schematically shown to provide an ability to mechanically move the closure latch assembly 210 from the latched state to the unlatched state without assistance from the power actuator 141. As such, in the event power is inadvertently interrupted to power actuator 141, a passenger inside the motor vehicle 14 can gain open and ready access to the emergency backup mechanism EBM′, such as via an access opening 202 covered and concealed by rear door handle 226, to manually move closure latch assembly 210 from the latched state to the unlatched state. Emergency backup mechanism EBM′ can be provided by a handle, lever, pull tab, pull ring PR, or the like, attached to a cable, such as a Bowden cable, that is mechanically coupled to a release lever RL (as shown in FIG. 28) that is moveable to move pawl to the ratchet releasing position, thereby causing latch assembly 210 to move from the latched state to the unlatched state. Accordingly, in a power-interrupted state, closure latch assembly 210 can be unlatched via manual actuation of mechanical linkage, though closure latch assembly 210 is intended to be solely actuatable in “normal use” by rear inside handle 226 via powered actuation as long as closure latch assembly 210 is not in the child lock ON position.

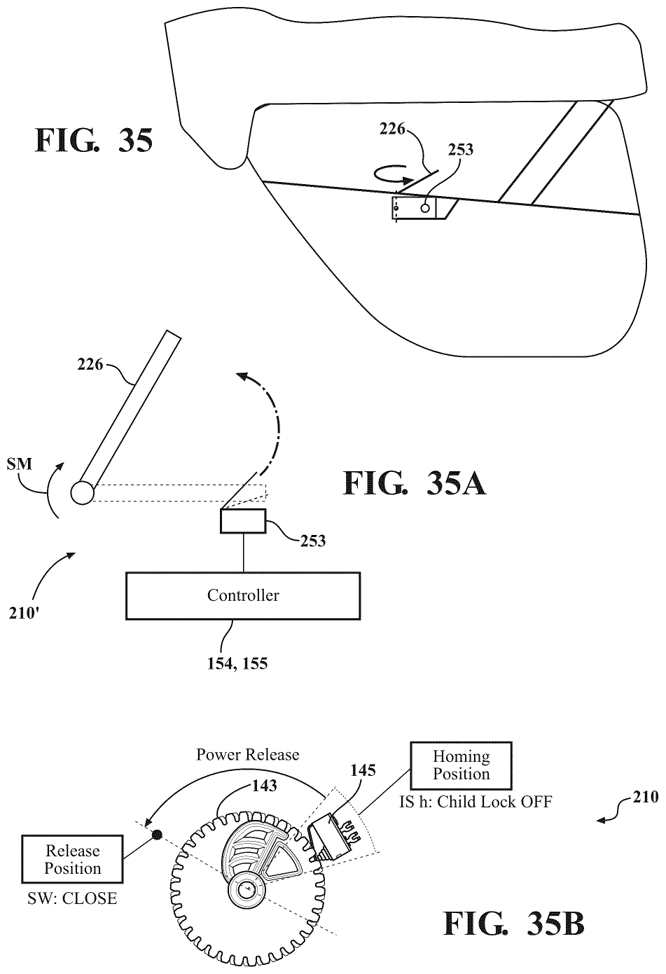

With reference to FIGS. 35 and 35A, when closure latch system 210′ is in the lock OFF and child lock OFF position, actuation of rear door handle 226 from a closed position, also referred to as rest position (FIG. 32), to a normal open position, also referred to as first deployed position or first position (FIG. 33), causes closure latch assembly 210 to move from the latched state to the unlatched state, thereby allowing rear door 12 to be opened. Movement of rear door handle 226 to the normal open position, with child lock in the off position, triggers an inside handle switch 253 that is configured in operable communication BCM 154 and/or latch controller 155, with at least one of BCM 154 and/or latch controller 155 being configured in operable communication with home position sensor/switch (first sensor) 143 (FIG. 35B), thereby causing the latch controller 155 to signal motor 141 to drive power release gear 143 to the release position, as discussed above, thereby causing closure latch assembly to move to the unlatched state. Rear door handle 226 can be biased by a rear handle biasing member, such as a suitable spring member SM, to return rear door handle 226 to the closed position, thereby causing switch 253 to become reset. A backup release mechanism, such as a lever or other type of manually actuated device (such as via a pull) and/or an electrical release mechanism such as a switch or button or other type of sensor when the latch assembly 110, 210 is configured with emergency back-up power (such as described in U.S. Pat. No. 10,378,251 entitled “Electronic latch of a motor-vehicle closure device, provided with an improved backup energy source” as one example, the entire contents of which are incorporated herein by reference) may be normally hidden and inaccessible by rear door handle 226, where rear door handle 226 also may function as a moveable lid or cover for concealing and exposing the backup release mechanism for allowing access of a user to the mechanism release mechanism. The movement of the lid or cover 226 may be detected and used to control the change of state of the latch assembly 110, 210 such that a subsequent single activation of the release mechanism will control release of the latch assembly 110, 210.

With reference to FIGS. 36 and 36A, when closure latch system 210′ is in the lock ON and child lock ON position, actuation of rear door handle 226 from the closed position (FIG. 32) to the normal open position (FIG. 33) fails to cause closure latch assembly 210 to move from the latched state to the unlatched state, thereby causing closure latch assembly 210 to remain in the latched state and rear door 12 to be maintained in the closed position. Movement of rear door handle 226 to the normal open position, with child lock ON, triggers an inside handle switch 253 that is configured in operable communication BCM 154 and/or latch controller 155, with at least one of BCM 154 and/or latch controller 155 being configured in operable communication with child lock position sensor/switch (second sensor) 147, thereby preventing the latch controller 155 from signaling motor 141 to drive power release gear 143 (FIG. 36B) to the release position, as discussed above, thereby maintaining closure latch assembly 210 in the latched state. Further, while in the child lock ON position, manual actuation of emergency backup mechanism EBM′ does not cause closure latch assembly 210 to move to the unlatched state, as discussed above for FIGS. 23 and 24.

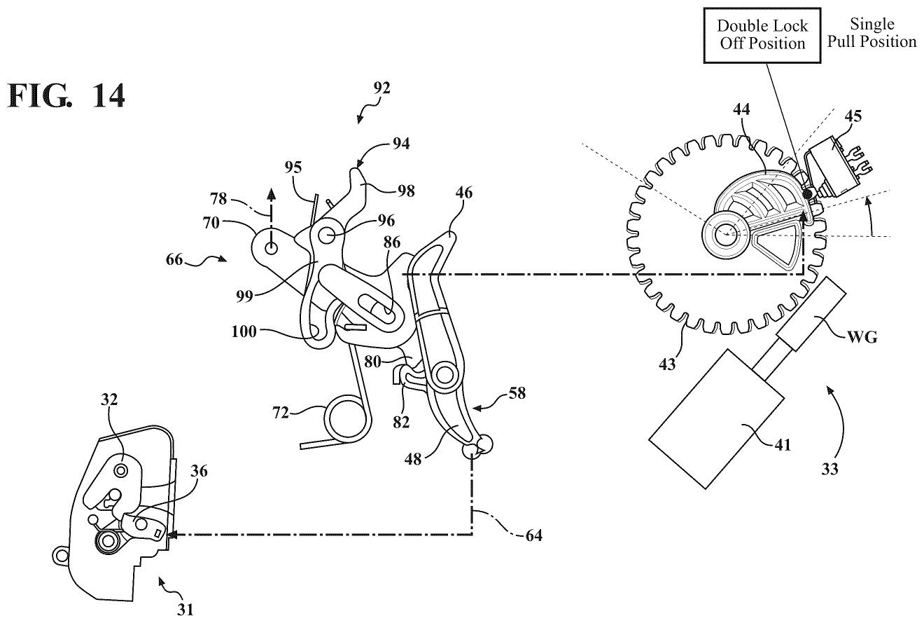

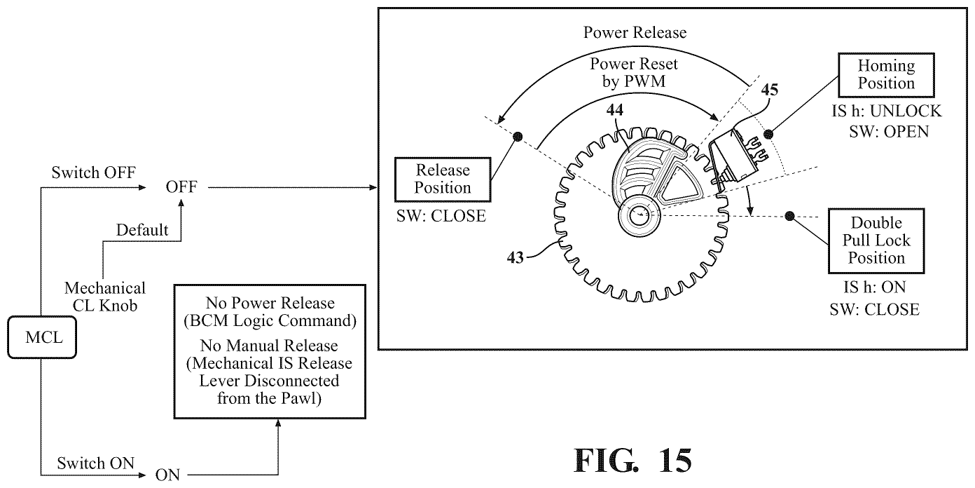

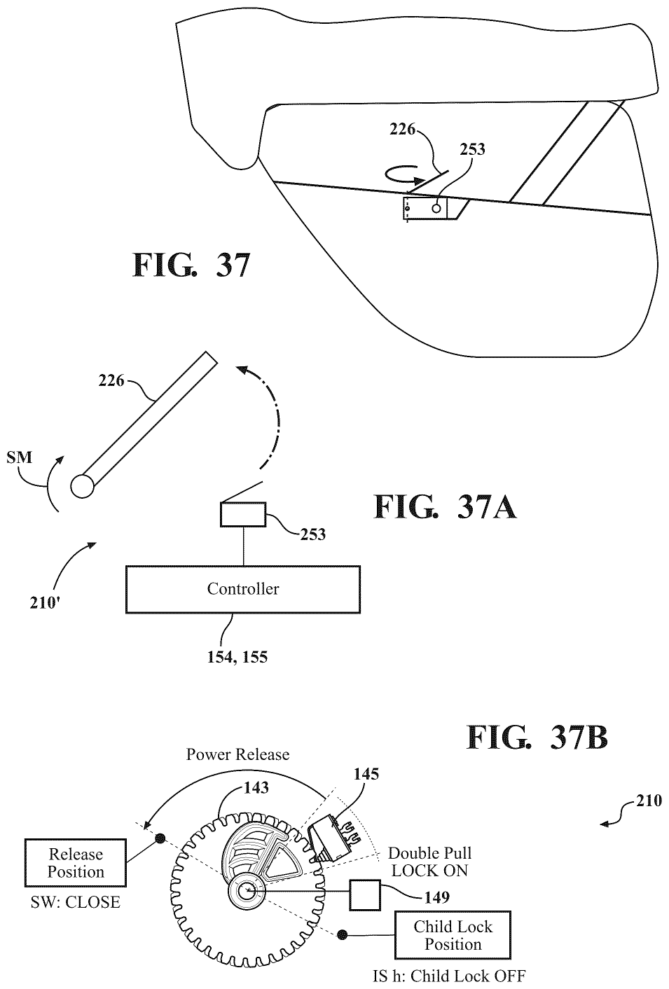

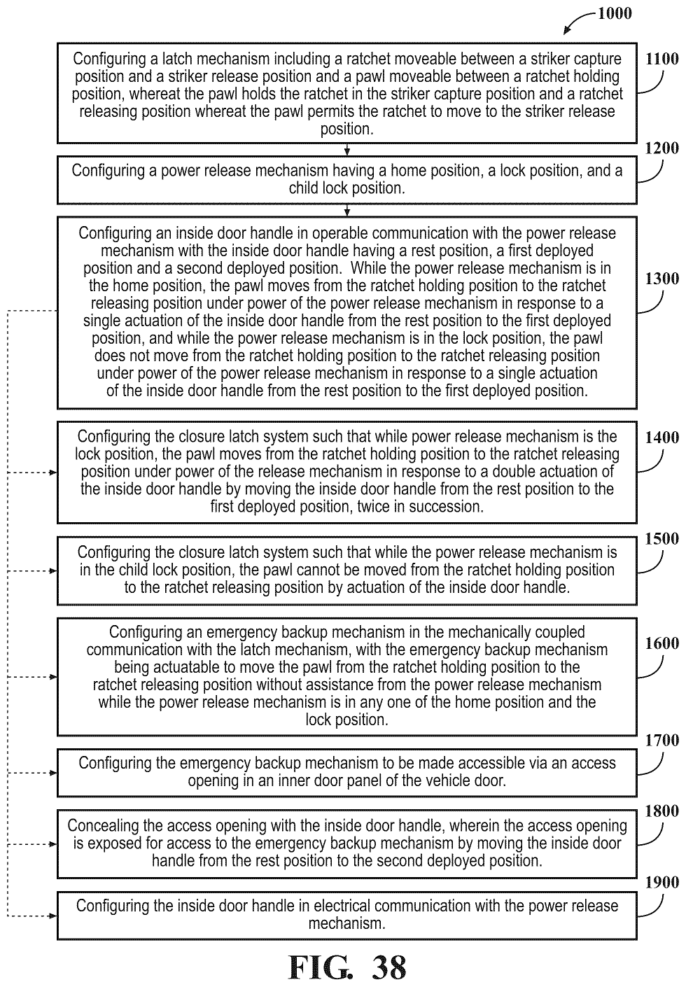

With reference to FIGS. 37 and 37A, when closure latch system 210′ is in the lock ON and child lock OFF position, a single actuation of rear door handle 226 from the closed position (FIG. 32) to the normal open position (FIG. 33) fails to cause powered movement of closure latch assembly 210 from the latched state to the unlatched state, thereby causing closure latch assembly 210 to remain in the latched state and rear door 12 to be maintained in the closed position. However, a second actuation, also referred to as double actuation, of rear door handle 226 from the closed position to the normal open position causes powered movement of closure latch assembly 210 from the latched state to the unlatched state, thereby causing closure latch assembly 210 to move to the unlatched state, thereby allowing rear door 12 to be opened, such as discussed above with regard to FIGS. 13, 14 and 15 (sequence 3-6). Movement of rear door handle 226 to the normal open position in the first actuation, with lock ON and child lock OFF position, triggers inside handle switch 253 that is configured in operable communication BCM 154 and/or latch controller 155, with at least one of BCM 154 and/or latch controller 155 being configured in operable communication with lock position sensor/switch (third sensor) 149, with the first actuation not being sufficient to cause the latch controller 155 to signal motor 141 to drive power release gear 143 (FIG. 37B) to the release position, as discussed above for FIG. 13, thereby maintaining closure latch assembly 210 in the latched state. But then, movement of rear door handle 226 to the normal open position in the second actuation, with lock ON and child lock OFF position, triggers inside handle switch 253, with the second actuation causing the latch controller 155 to signal motor 141 to drive power release gear 143 to the release position, as discussed above for FIG. 14, thereby causing closure latch assembly 210 to move from the latched state to the unlatched state. Accordingly, movement of the rear door handle 226 twice, from the rest, home position to the normal open position causing powered actuation of closure latch assembly 210 to move from the latched to the unlatched state.

Additionally, when closure latch system 210′ is in the lock ON and child lock OFF position, should a power interruption condition exist, actuation of the emergency backup mechanism EBM′ causes closure latch assembly 210 to move to the unlatched state, as discussed above for FIGS. 13 and 14. The user can simply move the rear door handle 226 from the rest position to an emergency open position, also referred to as second deployed position or second position (FIG. 34), with the second position being beyond the first position, thereby exposing access opening 202 such that the user can have ready access to emergency pull ring PR. Then, the user can simply perform a double actuation of emergency pull ring PR, thereby causing closure latch assembly 210 to move to the unlatched state. Accordingly, even during a power interruption, a rear seat passenger can override power release system, while closure latch system 210′ is in the lock ON and child lock OFF position, via mechanical actuation of emergency backup mechanism EBM′.

In accordance with another aspect of the disclosure, a method 1000 of constructing a closure latch system 210′ for a vehicle door 12 is provided. The method 1000 includes a step 1100 of configuring a latch mechanism 31 including a ratchet 32 moveable between a striker capture position and a striker release position and a pawl 36 moveable between a ratchet holding position, whereat the pawl 36 holds the ratchet 32 in the striker capture position and a ratchet releasing position whereat the pawl 36 permits the ratchet 32 to move to the striker release position. Further, a step 1200 of configuring a power release mechanism 133 having a home position, a lock position, and a child lock position; and a step 1300 of configuring an inside door handle 26 in operable communication with the power release mechanism 133 with the inside door handle 26 having a rest position, a first deployed position and a second deployed position. While the power release mechanism 133 is in the home position, the pawl 36 moves from the ratchet holding position to the ratchet releasing position under power of the power release mechanism 133 in response to a single actuation of the inside door handle 26 from the rest position to the first deployed position, and while the power release mechanism 133 is in the lock position, the pawl 36 does not move from the ratchet holding position to the ratchet releasing position under power of the power release mechanism 133 in response to a single actuation of the inside door handle 26 from the rest position to the first deployed position.

In accordance with a further aspect of the method 1000, a step 1400 includes configuring the closure latch system 210′ such that while power release mechanism 133 is in the lock position, the pawl 36 moves from the ratchet holding position to the ratchet releasing position under power of the release mechanism 133 in response to a double actuation of the inside door handle 26 by moving the inside door handle 26 from the rest position to the first deployed position, twice in succession.

In accordance with a further aspect of the method 1000, a step 1500 includes configuring the closure latch system 210′ such that while the power release mechanism 133 is in the child lock position, the pawl 36 cannot be moved from the ratchet holding position to the ratchet releasing position by actuation of the inside door handle 26.

In accordance with a further aspect of the method 1000, a step 1600 includes configuring an emergency backup mechanism (EBM′) in mechanically coupled communication with the latch mechanism 31, with the emergency backup mechanism EBM′ being actuatable to move the pawl 36 from the ratchet holding position to the ratchet releasing position without assistance from the power release mechanism 133 while the power release mechanism 133 is in any one of the home position and the lock position.

In accordance with a further aspect of the method 1000, a step 1700 includes configuring the emergency backup mechanism EBM′ to be made accessible via an access opening 202 in an inner door panel of the vehicle door 12.

In accordance with a further aspect of the method 1000, a step 1800 includes concealing the access opening 202 with the inside door handle 26, wherein the access opening 202 is exposed for access to the emergency backup mechanism EBM′ by moving the inside door handle 26 from the rest position to the second deployed position. It is to be recognized that the access opening 202 is intended to be inaccessible during normal use, and is further intended to be inconspicuous, such that the aesthetic appearance of the inside door handle region is pleasing. It is only when desired, such as during an emergency, including a power shortage to power release mechanism 133, that the access opening is intended to be exposed for access to the emergency backup mechanism EBM′, as will be understood by a person skilled in the art upon viewing the disclosure herein.

In accordance with a further aspect of the method 1000, a step 1900 includes configuring the inside door handle 26 in electrical communication with the power release mechanism 133, such that the only communication between the inside door handle 26 and the latch mechanism 31 can be made electrical, and not mechanical.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a vehicle door, comprising:
a latch mechanism including a ratchet and a pawl, the ratchet being moveable between a striker capture position and a striker release position, the pawl being moveable between a ratchet holding position whereat the pawl holds the ratchet in its striker capture position and a ratchet releasing position whereat the pawl permits the ratchet to move to its striker release position;
a power release mechanism moveable by a single power actuator, whereat the pawl can be moved from the ratchet holding position to the ratchet releasing position upon a single actuation of the power release mechanism; and
an emergency backup mechanism configured to provide mechanically actuated movement of the pawl from the ratchet holding position to the ratchet releasing position without assistance from the power actuator.

2. The closure latch assembly of claim 1, wherein the power release mechanism is moveable by the single power actuator between a home position, whereat the pawl can be moved from the ratchet holding position to the ratchet releasing position upon a single actuation of the power release mechanism or upon a single actuation of an inside handle, and at least one of a double pull lock position and a child lock position, whereat the pawl cannot be moved from the ratchet holding position to the ratchet releasing position upon a single actuation of the power release mechanism or upon a single actuation of the inside handle.

3. The closure latch assembly of claim 2, wherein the pawl, while the power release mechanism is in the double pull lock position, can be moved from the ratchet holding position to the ratchet releasing position upon performing a double actuation of the power release mechanism.

4. The closure latch assembly of claim 2, wherein the power release mechanism moves directly from the double pull lock position to the home position upon performing the double actuation of the power release mechanism.

5. The closure latch assembly of claim 2, wherein the pawl, while the power release mechanism is in the double pull lock position, can be moved from the ratchet holding position to the ratchet releasing position upon performing a double actuation of the inside handle.

6. The closure latch assembly of claim 5, wherein the power release mechanism, while in the double pull lock position, moves from the double pull lock position to the home position upon performing a first actuation of the power release mechanism.

7. The closure latch assembly of claim 2, further including a child lock switch configured in electrical communication with the single actuator to move the power release mechanism from the home position to the child lock position.

8. The closure latch assembly of claim 1, further including a cover configured to prevent inadvertent access to the emergency backup mechanism, said cover being selectively moveable to allow intended mechanical actuation of the emergency backup mechanism.

9. The closure latch assembly of claim 8, wherein the emergency backup mechanism includes a mechanically actuatable release chain operably coupled to a release lever, wherein the release lever is configured to move the pawl from the ratchet holding position to the ratchet releasing position upon selective actuation of mechanically actuatable release chain.

10. The closure latch assembly of claim 9, wherein the mechanically actuatable release chain includes an actuator member coupled to a Bowden cable, with the Bowden cable being coupled to the release lever.

11. The closure latch assembly of claim 8, wherein the cover is provided by an inside door handle.

12. The closure latch assembly of claim 11, wherein the power release mechanism is moveable by the single power actuator from a home position, whereat the pawl can be moved from the ratchet holding position to the ratchet releasing position upon a single actuation of the inside handle.

13. The closure latch assembly of claim 2, further including a cover configured to prevent inadvertent access to the emergency backup mechanism, said cover being selectively moveable from a rest position to an emergency open position to allow access to the emergency backup mechanism for mechanical actuation of the emergency backup mechanism.

14. The closure latch assembly of claim 13, wherein the cover is provided by the inside door handle.

15. The closure latch assembly of claim 14, wherein the emergency backup mechanism includes a mechanically actuatable release chain operably coupled to the pawl to move the pawl from the ratchet holding position to the ratchet releasing position upon selective actuation of mechanically actuatable release chain.

16. The closure latch assembly of claim 15, wherein while the power release mechanism is in the double pull lock position, a double actuation of the emergency backup mechanism causes the mechanically actuatable release chain to move the pawl from the ratchet holding position to the ratchet releasing position.

17. The closure latch system of claim 1, wherein the emergency backup mechanism is accessible via an access opening in an inner door panel of the vehicle door.

18. The closure latch assembly of claim 17, further including a cover configured to conceal the access opening to prevent inadvertent access to the emergency backup mechanism, wherein the cover is provided by an inside door handle.

19. The closure latch assembly of claim 18, wherein the power release mechanism is moveable by the single power actuator in response to actuation of the inside handle from a rest position to a deployed position.
